(19) United States
(12) Patent Application Publication
(10) Pub. No.: US 2019/0160568 A1
(43) Pub. Date: May 30, 2019

(54) DEVICES AND METHODS FOR MARKING CONDUCTIVE OBJECTS

(71) Applicant: Saunders Midwest LLC, Chicago, IL (US)

(72) Inventors: Walter J. SEDLACEK, West Chicago, IL (US); Douglas A. SPITLER, St. Charles, IL (US); Michael R. BARTHEL, Prospect Heights, IL (US); Champin CHOU, Hangzhou City (CN)

(73) Assignee: Saunders Midwest LLC, Chicago, IL (US)

(21) Appl. No.: 16/206,649

(22) Filed: Nov. 30, 2018

Related U.S. Application Data
(60) Provisional application No. 62/593,050, filed on Nov. 30, 2017.

(51) Int. Cl. B23H 9/06; B23H 3/08; B23H 3/04; B23H 1/02; C25F 3/14

(52) U.S. Cl. CPC B23H 9/06; B23H 3/08; C25F 3/14; B23H 1/02; B23H 3/04

(57) ABSTRACT

A marker apparatus includes a housing, a current controller that is electrically connected to an electrode, a pad connected to the electrode for retaining an electrolytic fluid, and a removable cover. The removable cover retains an insulated stencil to an outer surface of the pad. The insulated stencil defines at least one permeable portion therein and a portion of the outer surface of the pad adjoins the at least one permeable portion. The at least one permeable portion can be formed as at least one opening defined through the insulated stencil, in which the portion of the outer surface of the pad extends into the at least one opening. The current controller provides an electric current from the electrode through the at least one permeable portion that is electrically connected to an object to be marker. The marker apparatus can include an on-board reservoir of electrolytic fluid and an actuator.

### CROSS-REFERENCE TO RELATED APPLICATIONS

This application claims benefit of priority to U.S. Provisional Application Ser. No. 62/593,050, entitled “Etcher Device and Etching Method,” filed Nov. 30, 2017, which is incorporated herein by reference in its entirety.

### BACKGROUND

The embodiments described herein relate to metal marking devices and metal marking methods. More particularly, the embodiments described herein relate to integrated devices for marking and/or etching objects using electrochemical marking processes.

Known techniques for electrochemical marking (which can include electrochemical etching, electrochemical etch marking, electro etching, metal etching, or electrolytic etching) employ industrial machines to perform complicated steps and procedures to etch or deposit a desired shape on a metal object in a manufacturing environment. Such conventional processes are typically performed as part of an assembly line in which marked metal objects are being manufactured and/or are being assembled as components for end products. While these industrial techniques may be appropriate for mass production in which large quantities of the same object are being marked, these techniques are complex and difficult to perform when marking small numbers of objects and when marking different types of objects, as well as for use by individual users.

These known industrial metal marking procedures include forming a marking assembly by directly attaching an insulated etching mask or deposition mask to a surface of each metal object to be etched or upon which to receive metal deposition. The mask includes a permeable portion or set of openings that define a pattern to be marked on the surface via metal etching or deposition. The metal marking assembly is secured in a fixture and a cathodic or anodic first electrical connector is attached to a portion of the assembly that is electrically connected to the surface to be etched. A specific concentration of electrolytic solution is applied to the metal marking assembly over the mask, or the metal object with its mask are placed partially or fully within an electrolytic solution bath. A second electrical connector makes contact with the electrolytic solution and a potential difference is applied between the first electrical connector and the second electrical connector at a desired voltage. An electrical connection is formed through the electrolytic solution where the openings or permeable portion exist in the mask, which removes metal material from the surface at these locations or deposits metal material to the surface at these locations in the pattern defined by the openings or permeable portion. After the electrical connection ends and marking has completed, the marking assembly is disconnected from the electrical connection, removed from the fixture, and the marking assembly is disassembled by removing the insulated mask from the surface of the metal object.

These conventional marking techniques rely on the mask being affixed directly to the surface of the metal object, which protects surface areas beyond the openings and outside of the desired pattern from being marked. The affixed mask prevents inadvertent contact between electrolytic fluid and portions of the object surface beyond the openings or outside of the pattern defined by the openings. This includes inadvertent contact that can occur from excess electrolytic fluid being provided to the surface or from electrolytic fluid splashing on the surface or flowing to areas outside of the pattern.

Known do-it-yourself techniques are similarly complex and overly cumbersome. In such known techniques, the operator performs convoluted laboratory-type procedures that are similar to the automated procedures performed by industrial machines described above. These techniques include the operator affixing tape or another mask material directly to a metal object to be marked and cutting a desired etch pattern out of the tape or mask material attached to the object. Similar to known industrial techniques, the mask material is affixed directly to the metal object in order to protect surface areas beyond the pattern from being marked by preventing electrolytic fluid from reaching those areas.

For these known do-it-yourself techniques, the operator manually attaches a first connector to the metal object and electrically connects the first connector to a negative or positive pole of a battery. The operator applies an electrolytic solution to the electrically connected assembly of the mask material and the metal object by dripping, pouring or wiping the electrolytic fluid over the mask material, and relies on the mask material to prevent the electrolytic solution from contacting surface areas beyond the pattern. The operator attaches a second connector to the opposite one of the negative or positive pole of the battery and places the second connector in electrical contact with the electrolytic solution covering the mask material and the portions cut from the mask material, which completes an electrical circuit between the battery poles through the electrolytic fluid along the cut openings.

The operator maintains the electrical circuit as long as desired provided sufficient electrolytic solution is present in the pattern openings. Similar to the industrial techniques, the operator thereafter disconnects the electrical connection from the metal object and proceeds to remove the mask material from the metal object. Multiple factors affect outcomes of these overly cumbersome known techniques, which provide results that are highly variable and user-dependent. These factors include the chemical composition and concentration of the electrolytic solution, the voltage and current applied to the circuit, the duration of the circuit, the type of metal of the object and its composition at the surface and along the electrical path through the object, the type of metal marking including etching and metal deposition, characteristics of the marking including etch depth or deposition thickness, and the level of insulation and protection provided by the tape or mask material.

Thus, a need exists for improved electrochemical marking devices and methods for marking various types of objects, marking small quantities of objects, and for performing marking by individual users in a non-production environment. Further, a need exists for metal marking devices that are relatively easy to use, and for marking methods that are simple to perform for applying consistent quality marks on a many different types of objects.

### SUMMARY

This summary introduces certain aspects of the embodiments described herein to provide a basic understanding. This summary is not an extensive overview of the inventive subject matter, and it is not intended to identify key or critical elements or to delineate the scope of the inventive subject matter. In some embodiments, a marker apparatus includes a housing, a current controller disposed within the housing that is electrically connected to an electrode and to a target surface connector that are each configured to be electrically connected to a power source, and a marker assembly mounted on the housing configured to contact a target surface to be marked and outline a surface area to be marked on the target surface. The marker assembly includes a pad connected to the first electrode configured to retain an electrolytic fluid, and a removable cover coupled to the housing configured to retain an insulated stencil to an outer surface of the pad. The insulated stencil defines at least one permeable portion therein, and a portion of the pad adjoins the permeable portion when the cover retains the insulated stencil to the outer surface of the pad. In some configurations, the permeable portion includes at least one stencil opening defined through the insulated stencil and the portion of the pad adjoining the at least one permeable portion extends through the at least one stencil opening. In some configurations, the portion of the pad extends through the at least one stencil opening such that a distal end of the portion of the pad extends beyond an outer surface of the insulated stencil.

In some embodiments, a marker apparatus includes a housing, a current controller disposed within the housing, a pad coupled to the housing, and a cover removably coupled to the housing. The current controller is electrically connected to an electrode and to a target surface connector configured to be electrically connected to a power source. The pad is electrically connected to the first electrode and is configured to retain an electrolytic fluid. The cover is configured to retain an insulated stencil, which defines at least one permeable portion, over an outer surface of the pad. In some configurations, the marker apparatus further includes a conduit attached to the housing that defines a pathway through which the electrolytic fluid can be conveyed to the pad, a reservoir attached to (or within) the housing and connected to the conduit that is configured to contain the electrolytic fluid, and a valve configured to selectively permit the electrolytic fluid to flow from the reservoir to the pad. In other configurations, the marker apparatus further includes a reservoir attached to the housing that is configured to contain the electrolytic fluid, and an actuator. The actuator is coupled to the housing and is configured to be manipulated to move the actuator relative to the housing. The actuator includes a switch portion configured to actuate a switch to electrically connect the current controller to the first electrode. The actuator can further include a valve portion configured to open a valve to allow the electrolytic fluid to flow from the reservoir to the pad.

Other devices, systems, components, features, implementations, methods and/or products according to embodiments will be or become apparent to one with skill in the art upon review of the following drawings and detailed description. It is intended that all such additional devices, systems, components, features, implementations, methods, and/or products be included within this description, be within the scope of this disclosure.

### BRIEF DESCRIPTION OF THE DRAWINGS

FIG. 1 is a perspective view of an integrated marker device according to an embodiment.

FIG. 2A is a perspective view of a distal portion of the integrated marker device shown in FIG. 1.

FIG. 2B is an exploded perspective view of the distal portion of the integrated marker device shown in FIG. 2A.

FIG. 3A is a perspective view of the distal portion of the integrated marker device shown in FIG. 2A shown in an illustrative usage environment along with an example object to be etched.

FIG. 3B is a perspective view of the integrated marker device shown in FIG. 1 shown in another illustrative usage environment with the example object shown in FIG. 3A.

FIG. 4A is a perspective view of an integrated marker device according to another embodiment shown in an illustrative usage environment with an example object to be marked.

FIG. 4B is a perspective view of the example object shown in FIG. 4A shown in a post-marking configuration.

FIG. 4C is side perspective view of the integrated marker device shown in FIG. 4A.

FIGS. 5A and 5B are schematic side views and top views respectively of a marker assembly shown in isolation according to an embodiment.

FIG. 6A is a perspective view of stencil dispenser shown in isolation according to an embodiment.

FIG. 6B is a cross-sectional view of a portion of the stencil material shown in FIG. 6A.

FIG. 7 is a perspective view of an integrated marker device according to yet another embodiment.

FIG. 8A is a schematic elevation view of an openable and closable removable cartridge for retaining a stencil and a pad shown as a component of a marker assembly of the integrated marker device shown in FIG. 7, which is shown in the open position in isolation without other components.

FIG. 8B is an end view of the openable and closable removable cartridge shown in FIG. 8A, which is shown in the open configuration with example stencil and pad components.

FIG. 8C is an end view of the openable and closable removable cartridge shown in FIG. 8B, which is shown in the closed configuration.

FIG. 9 is a perspective, partial cross-sectional view of a portable integrated marker device according to an embodiment.

FIG. 10 is a perspective view of an actuator assembly and an electrolytic solution delivery system of the portable integrated marker device shown in FIG. 9.

FIG. 11 is a top, cross-sectional view of a handle portion of the portable integrated marker device shown in FIG. 9 taken along line 11-11 shown in FIG. 9.

FIG. 12 is a perspective view of an integrated marker device according to an embodiment.

FIG. 13 is a flow chart illustrating a method for etching a metallic object according to an embodiment.

FIG. 14 is a flow chart illustrating a method for etching a metallic object according to an embodiment.

FIG. 15 is a perspective view of an integrated metal marker device according to an embodiment.

FIG. 16 is a side perspective view of a distal portion of the integrated metal marker device shown in FIG. 15.

FIG. 17 is an exploded side perspective view of the distal portion of the integrated metal marker device shown in FIG. 16.

FIG. 18 is cross-sectional view of a portion of the integrated metal marker of FIG. 15 as viewed from line X-X shown in FIG. 15.

FIG. 19A is a rear perspective view of an electrolytic pump assembly, an electrolytic solution delivery system, and an actuator assembly of the integrated metal marker shown in FIG. 15.

FIGS. 19B, 19C, and 19D are views of portions of the electrolytic pump assembly of the metal marker shown in FIG. 15, which illustrate operational aspects and options for the pump assembly.

FIG. 20 is a perspective view of an integrated metal marker device according to an embodiment.

### DETAILED DESCRIPTION

The embodiments described herein can advantageously be used in a variety of metal marking devices, tools, components, methods and operations associated with electrochemical marking. In particular, the devices described herein can be integrated metal marking devices, portable metal marking devices, and accessories and components for marking devices including, for example, stencil dispensers, stencil materials, marker assemblies, cartridges and containers for marker assemblies, electrolytic solutions, electrolytic containers, and handheld metal marker devices. Further, it is understood that, as used herein, that electrochemical marking (also known as electro marking or electro metal marking) refers to a technique for marking a surface layer of a conductive surface by applying an electrical current to the surface layer via an appropriate electrolytic fluid in contact with surface layer, in which the electrolytic fluid corresponds with a type of marking technique appropriate for the type of material for the conductive surface.

Although the type of material forming the conductive surface can be a metal or metallic material, the technique is not limited to metal or metallic materials. For example, any of the devices and methods described herein can be used to mark a conductive plastic or silicone material, and/or a metal, metallic or other conductive coating formed on a plastic, ceramic, or other base material can be electrochemically marked. Further, the material to be marked can include metal objects, metallic devices, semi-metallic objects and other products, devices and/or assemblies that include as a component or portion thereof a metal object, metallic object, a semi-metallic object, or another conductive material or surface thereof. With respect to materials to be marked formed from metal or metallic materials, as examples these materials can include, without limitation, stainless steel, carbon steel, hard high alloy steel, aluminum, aluminum alloys, and surface plated chromium metals (e.g., galvanize nickel plating).

As used herein, electrochemical marking, electromarking or metal marking refers to the controlled removal from, chemical modification of, or metallic deposition to, a surface layer of a conductive material via an electric current applied to the surface layer in the presence of a corresponding electrolytic fluid. As example, metal marking can include forming an oxide layer on the target surface, such as forming an aluminum oxide layer in the surface of an aluminum object. As another example, metal marking can include etching a thin layer of the target surface, and accelerating corrosion in the surface. As used herein, an electrolytic fluid refers to a conductive fluid that is formulated to have an appropriate chemical composition that corresponds with the type of material to be marked and the type of marking operation, such that the fluid enables removing, chemically modifying, and/or adding material to the surface layer of the material to be marked. The depth of the mark formed in the surface can be shallow, such as only a few microns deep, but can nonetheless be a permanent mark formed in the material. Such marking operations can be performed quickly using the devices and methods described herein, such as in a matter of seconds, at ambient temperatures, and by applying a low voltage of about 20 volts or less to the object. As such, the electrochemical marking devices and methods described herein can be performed with little risk of deforming the material to be marked, inducing stress fractures, or otherwise impairing the structural integrity of the material or object, and can provide high quality, consistent, and permanent marks in such objects when marked using the marker devices described herein.

Various example features, aspects, configurations, components, assemblies, and arrangements are generally described herein pertaining to a marker device, such as marker device 100, which can be used to easily create a mark on a surface of an object without the use of complex equipment or fixtures to retain the object, and without being required to attach an insulated mask directly to the object. Embodiments of marker devices described herein are configured to operate as an integrated marker device that an operator can use to create a high-quality mark on a target surface of an object without specially preparing the target surface (e.g., taping a mask to the target surface). The user can simply electrically connect a contact portion of the marker device to the target surface to be marked along with electrically connecting a first target surface connector to the target surface and actuating an electric current to flow between the contact portion and the first target surface connector through the target surface. The contact portion of the marker device is configured to form a matching shape, pattern or arrangement that corresponds with the mark to be marked in the contact surface. The marker device controls the flow and orientation of electrical current at the target surface during marking through the contact portion, so that the target surface is marked with the desired mark.

As such, components and features for controlling electric current to flow through the contact portion according to the configuration of marking a target surface of an object are integrated within the embodiments of the marker devices described herein. Thus, special preparations for the target surface are not needed to perform marking operations. For example, the special fixtures of conventional etching devices and systems for holding and grounding the target surface during etching or deposition are not needed while using the embodiments of marker devices herein to mark a target surface.

In some embodiments, a marker device can include a current controller configured to apply a customized electric potential between the electrode of the device and the target surface connector electrically connected to the target surface. Thus, the current controller controls an electric potential or current between the electrode and the target surface connector during a selected type of electrochemical marking (e.g., whether A/C or D/C, the magnitude of the current, the waveform of the current, and/or the characteristics of the current as a function of time during the marking operation). The customized electric potential can be determined according to the type of the electrochemical marking selected by the user and/or that corresponds with the object to be marked. Thus, based on the type of electrochemical marking selected by the user, the current controller of the marker device provides a customized electric potential or current that includes at least a cathodic direct current electric potential, an anodic direct current electric potential, and an alternating current electric potential. Thus, in some embodiments, the marker devices described herein can be used to mark many different types of conductive objects and perform various types of marking operations. In addition to the electric potential being customized for the type of marking and material to be marked, the current controller can adjust the characteristics of the electric current based on various parameters, such as automatically adjusting the current based on a flow rate of the electrolytic fluid sensed and/or the actual current detected during marking. In addition, the characteristics of the electric current can be optimized to enhance the type of mark provided, such as increasing or decreasing the voltage or magnitude of current applied during marking in accordance with a depth of material being added or removed from the surface.

In addition, in some embodiments, separate coatings, masks, covers, stencils and the like used with conventional marking technologies for retaining the target surface for marking operations and for protecting the target surface from inadvertent marks are also not needed. Rather, the methods described herein can be completed using any of the integrated devices described herein.

Embodiments of marker devices described herein use a pad that is configured to retain electrolytic fluid as part of a mechanism for controlling marking operations to provide electric current through the target surface to be marked. In some embodiments, a contact portion of an outer surface of the pad has a shape or arrangement that corresponds with a desired mark for the target surface. The contact portion of the outer surface of the pad is arranged to deliver the electrolytic fluid into electrical contact with the target surface while the contact portion has the configuration corresponding to the desired mark for the target surface. Mechanisms for configuring the contact portion of the pad to have the corresponding arrangement for the mark are described in greater detail below. These mechanisms include innovative arrangements of features for configuring the contact portion of the outer surface of the pad, such as configuring the marker device for use with a marker stencil having at least one permeable portion or at least one opening formed therein that can assist with forming the desired configuration of the contact portion. Other features provide further advantages for configuring the contact portion and controlling the flow of electric current during marking according to the corresponding arrangement for the mark, such as a removable cover, a removable stencil assembly container, a marker assembly and adjustable features related to the delivery and flow of the electrolytic fluid during marking operations.

In some embodiments, the marker device includes a pad electrically connected to a first electrode. The pad is configured to retain an electrolytic fluid, and the marker device is configured to control the electric current that flows from the first electrode through the electrolytic fluid in the pad and the contact portion of the pad to the target surface. In some embodiments, the contact portion of the outer surface of the pad extends through at least one stencil opening having a pattern or shape of a desired mark for the target surface. The electrolytic fluid in the contact portion extending through the at least one stencil opening electrically connects with the target surface for the mark. As such, the pad controls the delivery of electrolytic fluid that electrically connects to the surface to be marked and allows delivery of the fluid in the corresponding configuration for the mark without requiring a mask or other protective cover to be attached to the target surface. In some embodiments, the pad is configured to control a flow of the electrolytic fluid through the pad during marking operations, such as via wicking the electrolytic fluid through the pad to replace electrolytic fluid that is consumed during marking operations. In other embodiments, the pad is configured to guide a flow of the electrolytic fluid being driven to the pad by a pump or from a pressurized supply of the electrolytic fluid.

In some embodiments, a cover retains an insulated stencil to an outer surface of the pad, which thereby configures the contact portion of the pad in the corresponding configuration for creating the mark. In some embodiments, the insulated stencil defines the configuration of the contact portion of the pad, which in turn defines the configuration of the mark for the target surface, via at least one permeable portion formed in the insulated stencil. The at least one permeable portion of the insulated stencil can act to permit the electrolytic fluid to permeate through the stencil along the at least one permeable portion and otherwise restrict the electrolytic fluid from permeating through the stencil. This limits the electrical connection for marking so that electric current only flows to the target surface at the location of the at least one permeable portion when the insulated stencil is retained to the pad by the cover. As such, the contact portion of the pad is configured to form a mark in a target surface via portions of the outer surface of the pad that adjoin the at least one permeable portion.

Thus, the insulated stencil retained by the cover to the outer surface of the pad outlines the electrical connection to occur with the target surface for creating the desired mark. In this manner, the delivery, flow and orientation of the electrolytic fluid that is provided to the target surface via the contact surface is tightly controlled, as is the flow of electric current therethrough during marking operations. This arrangement provides various advantages including creating high quality marks on the target surface in the desired pattern while also greatly reducing the likelihood of errant delivery of fluid (e.g., splashing, leaking outside of the shape or pattern of the desired mark, or the like) and significantly simplifying operations for creating marks in target surfaces.

In some embodiments, the mark can be created in the target surface by electrochemically removing material from the target surface when the current flows through the electrolytic fluid to the target surface, which can etch the mark into the target surface. The depth of the etch can vary depending on factors such as the type of material forming the object and the target surface, the type and concentration of the electrolytic fluid, the amount of current that flows through the target surface during the marking operation, and the amount of time that the marking operation is applied to the object surface. In some embodiments, the mark can be created in the target surface electrochemically changing material at the target surface when the current flows through the electrolytic fluid to the target surface. As an example, a rate of corrosion can be accelerated at the target surface within the shape of the mark during the marking operation, which can chemically modify exposed material at the target surface to have a different color, such as change to a black or dark brown color. In some embodiments, the mark can be created in the target surface by electrochemically depositing a thin layer of material to the target surface when the current flows through the electrolytic fluid such that the thin layer of material bonds with the target surface. As an example, a metal material within the electrolytic material deposited on the target surface when the current flows through the electrolytic fluid.

In some embodiments, the cover and the pad are part of a marker assembly attached to a distal end of a housing, which cooperate with an insulated stencil to form the contact portion of the pad in the necessary configuration to form the mark. In some embodiments, the insulated stencil defines at least one stencil opening formed through stencil and the contact portion of the pad extends into the at least one stencil opening. In some embodiments, the contact portion of the pad extends through and distally beyond the at least one stencil opening. In some embodiments, the cover defines a cover opening, the contact portion of the pad extends into the at least one stencil opening, and the contact portion of the pad further extends through the cover opening to extend distally beyond an outer surface of the removable cover. Each of these embodiments and the corresponding features of these embodiments pertain to the various embodiments of marker devices and can be provided in various arrangements of the marker device in differing combinations with aspects and features related to embodiments of the marker device.

In some embodiments, the marker device includes a housing having a handle portion at a proximal end and an opposite, generally distal end to which the pad is attached. A current controller is disposed within the housing and is electrically connected to a device electrode and to a target surface connector. The current controller is configured to be electrically connected to a power source. In some embodiments, a target surface connector is disposed at the distal end of the housing and is configured to electrically connect to a surface to be marked when the contact portion of the pad electrically connects to the surface, such as via a spring-loaded target surface connector, a retractable target surface connector, and the like disposed at the distal end of the housing. In some embodiments, the target surface connector is attached to the housing and includes a removable target surface connector connected to the housing via a flexible cord, such as an alligator-type clip, an adjustable clamp, a bolted connector, or the like attached to an end of an electric cord. Such a configuration for the target surface connector can provide advantages for electrically connecting the target surface connector to various shapes, orientations, and positions of the target surface to be marked. In some embodiments, the target surface connector is configured to apply a negative charge when the current flows during marking operations. In some embodiments, the target surface connector is configured to apply a positive charge when the current flows during marking operations.

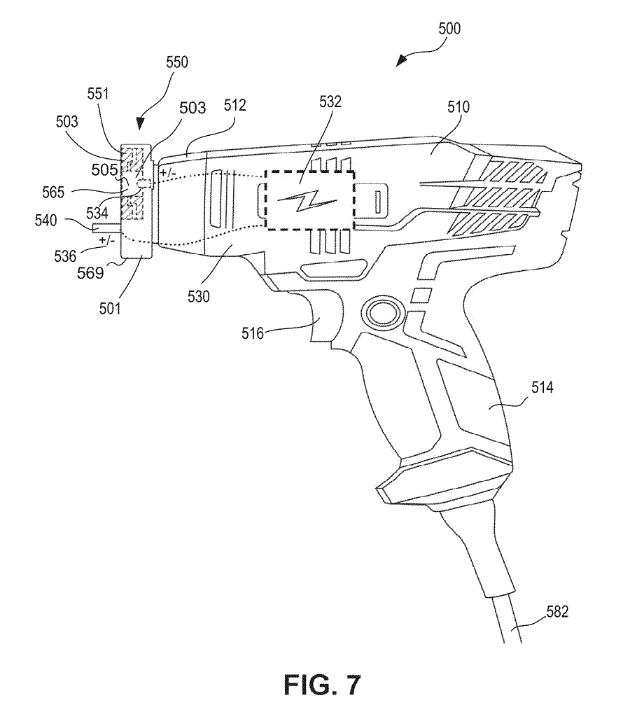

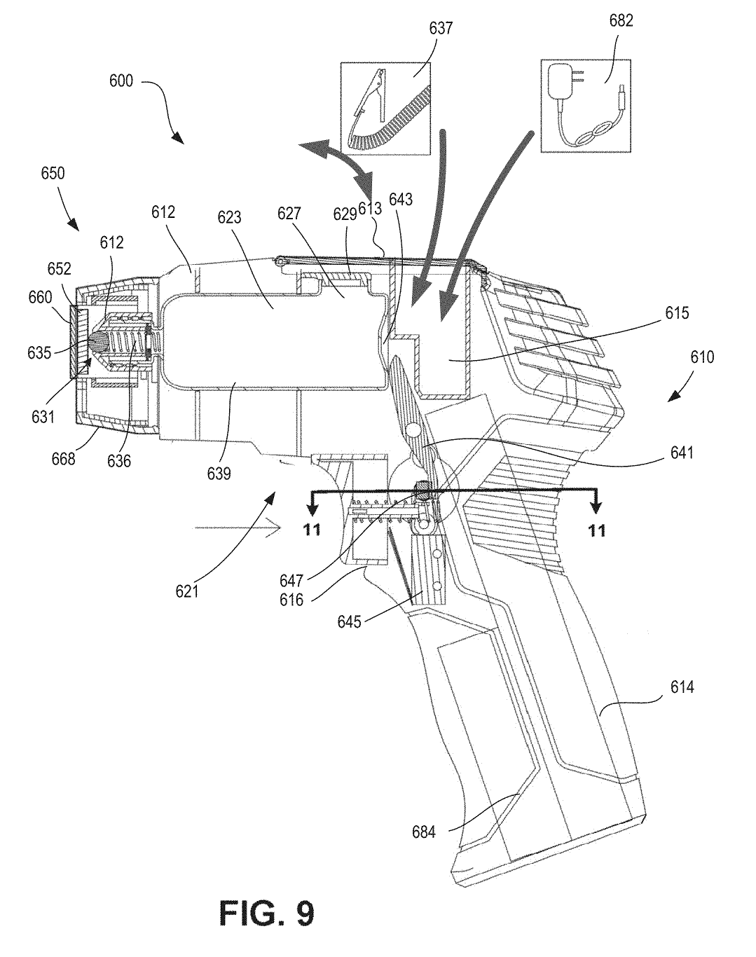

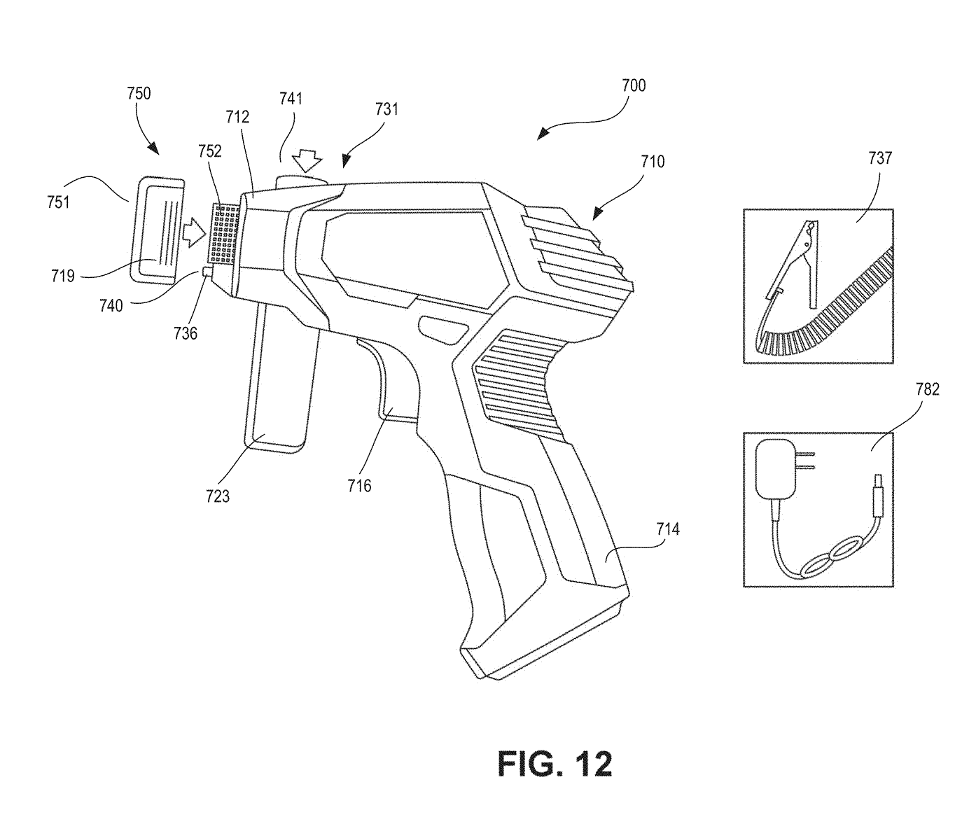

In some embodiments (see e.g., FIGS. 7 and 12), the power source includes an alternating current power source, and the marker device includes a power cord that connects with the power source. The marker device also includes a transformer inside the housing and/or attached to the power cord that transforms the power source input into a desired output voltage and type, such as a direct current output. In some embodiments (see e.g., FIG. 9), the power source includes a battery retained within the housing, such as a rechargeable internal battery. In some embodiments, the housing includes a storage area formed therein to store accessories for the marker apparatus, such as to store a removable target surface connector, a removable power cord for recharging the rechargeable battery, an additional pad, insulated stencils and the like.

In some embodiments, the marker device includes an on-board container that contains the electrolytic fluid and a system or mechanism that can convey the electrolytic fluid to the pad. In some embodiments, the on-board container is removably attached to the housing and can easily be refilled when detached. In some embodiments, the on-board container is retained within the housing and the housing includes a fill opening that allows electrolytic fluid to be added into the on-board container when needed. In some embodiments, the marker device includes a valve that allows electrolytic fluid to flow from the on-board container to the pad in a controlled manner In some embodiments, the marker device includes a spray nozzle coupled to the container that allows electrolytic fluid to flow from the container to the pad in a desired pattern (e.g., to prevent drips, spills, pooling or puddling).

In some embodiments, the marker device includes a pump to drive electrolytic fluid to flow to the pad. In some embodiments, the marker device includes an actuator on the housing that actuates the valve or pump to produce a flow of electrolytic fluid to the pad. In some embodiments, the marked device includes a manual pump that a user can operate to increase pressure in the electrolytic container to drive the electrolytic fluid. In some embodiments, the marker device includes an electric switch to activate the current controller to provide electric current between the electrode and the target surface connector during etching operations. In some embodiments, when actuated, the actuator closes the switch and also actuates the pump or valve, such that the actuator can act as a dual-purpose actuator. In some embodiments, the device includes a toggle switch that determines whether the actuator actuates the pump or valve along with closing the switch. The embodiments noted herein and the corresponding features identified with the various embodiments can cooperate with other features of embodiments of the marker device described herein to provide advantages for the various usages, types and arrangements of marker devices.

As used herein, the term “about” when used in connection with a referenced numeric indication means the referenced numeric indication plus or minus up to 10 percent of that referenced numeric indication. For example, the language “about 50” covers the range of 45 to 55. Similarly, the language “about 5” covers the range of 4.5 to 5.5.

The term “flexible” in association with a part, such as a mechanical structure, component, or component assembly, should be broadly construed. In essence, the term means the part can be repeatedly bent and restored to an original shape without harm to the part. Certain flexible components can also be resilient. For example, a component (e.g., a flexure) is said to be resilient if possesses the ability to absorb energy when it is deformed elastically, and then release the stored energy upon unloading (i.e., returning to its original state). Many “rigid” objects have a slight inherent resilient “bendiness” due to material properties, although such objects are not considered “flexible” as the term is used herein.

As used in this specification and the appended claims, the word “distal” refers to direction towards a work site, and the word “proximal” refers to a direction away from the work site. Thus, for example, the end of a marker device that is closest to the target object or target surface to be etched would be the distal end of the marker device, and the end opposite the distal end (i.e., the handle end manipulated by the user) would be the proximal end of the marker device.

Further, specific words chosen to describe one or more embodiments and optional elements or features are not intended to limit the invention. For example, spatially relative terms—such as “beneath”, “below”, “lower”, “above”, “upper”, “proximal”, “distal”, and the like—may be used to describe the relationship of one element or feature to another element or feature as illustrated in the figures. These spatially relative terms are intended to encompass different positions (i.e., translational placements) and orientations (i.e., rotational placements) of a device in use or operation in addition to the position and orientation shown in the figures. For example, if a device in the figures is turned over, elements described as “below” or “beneath” other elements or features would then be “above” or “over” the other elements or features. Thus, the term “below” can encompass both positions and orientations of above and below. A device may be otherwise oriented (e.g., rotated 90 degrees or at other orientations) and the spatially relative descriptors used herein interpreted accordingly. Likewise, descriptions of movement along (translation) and around (rotation) various axes includes various spatial device positions and orientations.

Similarly, geometric terms, such as “parallel”, “perpendicular”, “round”, or “square”, are not intended to require absolute mathematical precision, unless the context indicates otherwise. Instead, such geometric terms allow for variations due to manufacturing or equivalent functions. For example, if an element is described as “round” or “generally round,” a component that is not precisely circular (e.g., one that is slightly oblong or is a many-sided polygon) is still encompassed by this description.

In addition, the singular forms “a”, “an”, and “the” are intended to include the plural forms as well, unless the context indicates otherwise. The terms “comprises”, “includes”, “has”, and the like specify the presence of stated features, steps, operations, elements, components, etc. but do not preclude the presence or addition of one or more other features, steps, operations, elements, components, or groups.

Unless indicated otherwise, the terms apparatus, device, tool, marker and variants thereof, can be interchangeably used.

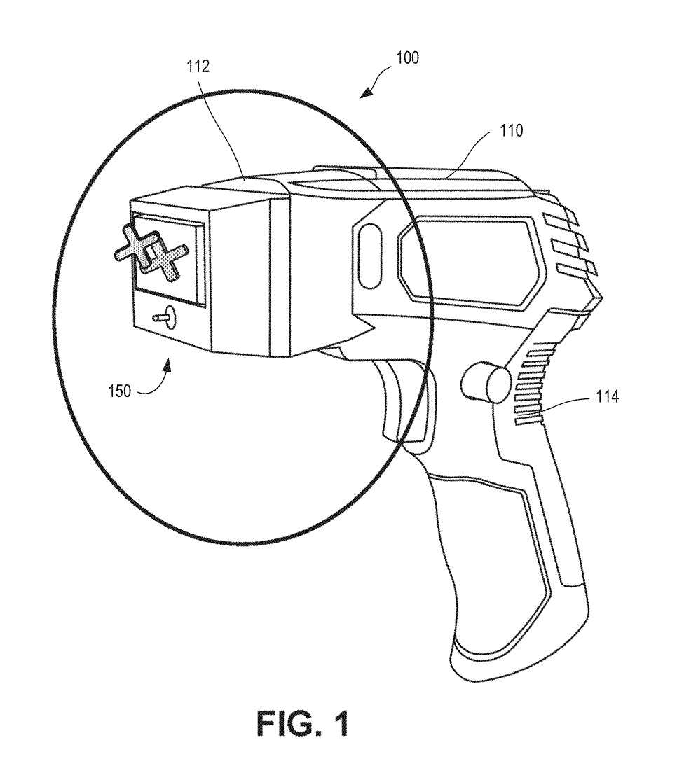

Referring now to FIGS. 1-3B, an example marker device 100 is generally shown as an integrated electrochemical marker that can be used to easily form a desired mark at a target surface of an object without needing to use complex equipment or fixtures to retain the object and without needing to attach an insulated mask or stencil to the object. As shown, marker device 100 includes a housing 110, electrical components (also referred to as the electrical assembly) 130, and a marker assembly 150.

The housing 110 includes a distal end 112, a generally opposite handle portion 114, and an actuator 116. The handle portion 114 permits the user to manipulate the marker device 100 and place the distal end 112 proximate a surface 192 of an object 190 to be marked. The actuator 116 is arranged as a movable trigger 116 in the example shown so that the user can move the actuator to activate the marker device 100 for marker operations. The housing 110 defines a volume (not shown) within which the electrical components 130 are disposed, for storage of accessories (e.g., replacement pads, additional wires), or for containing a power source (e.g., a battery).

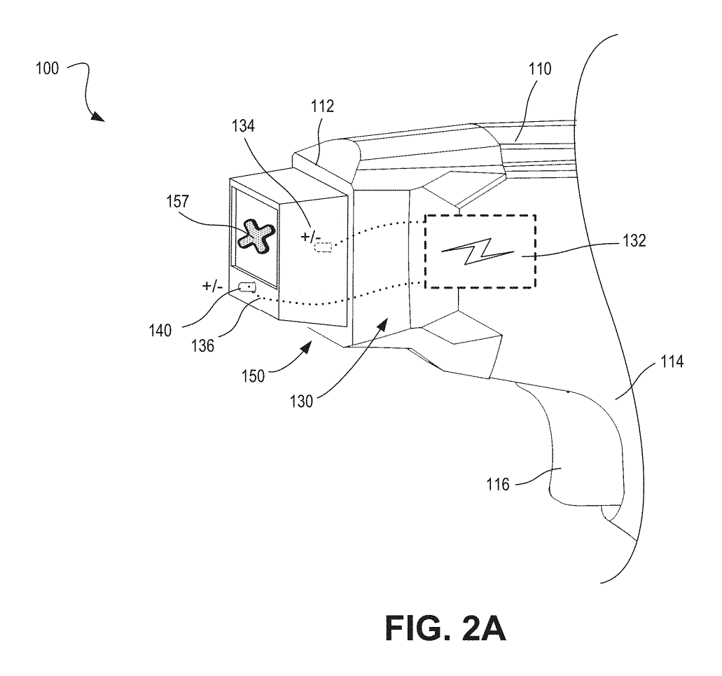

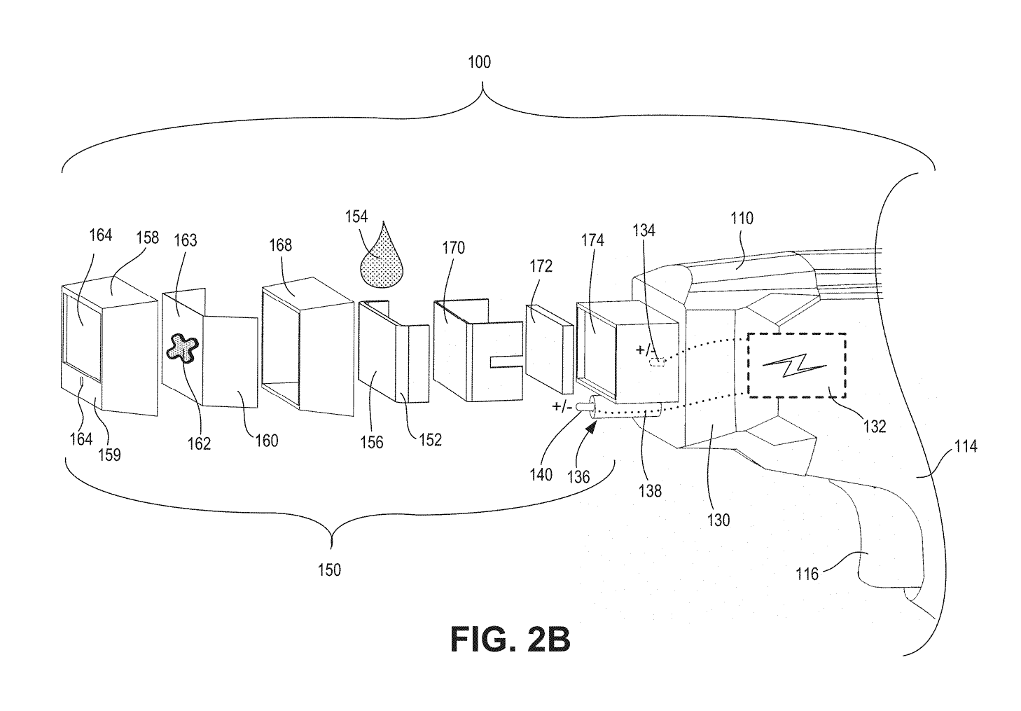

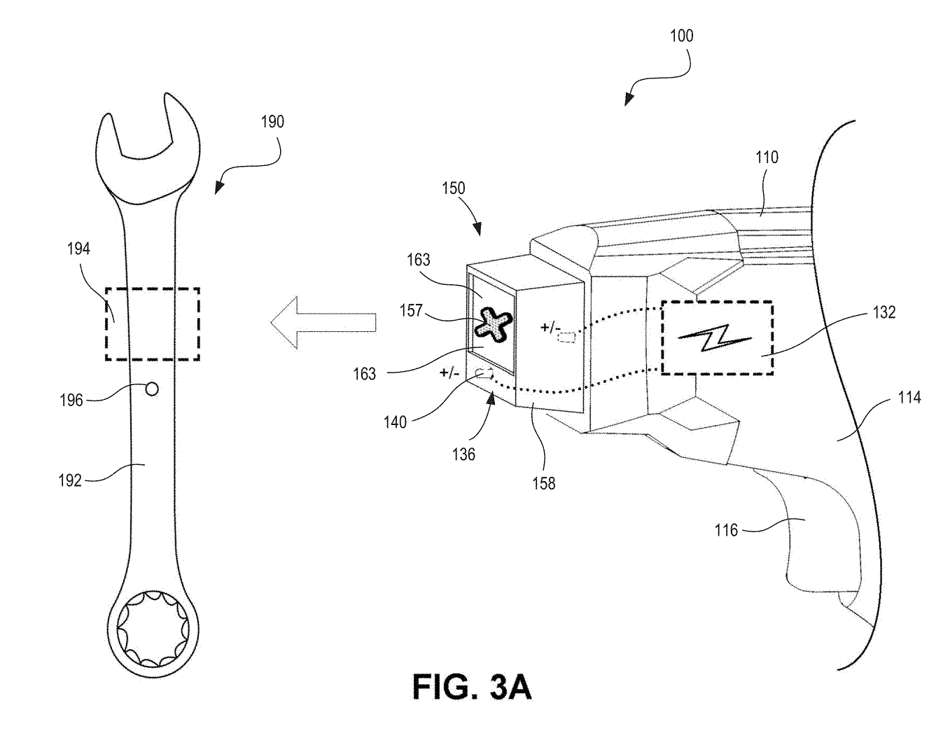

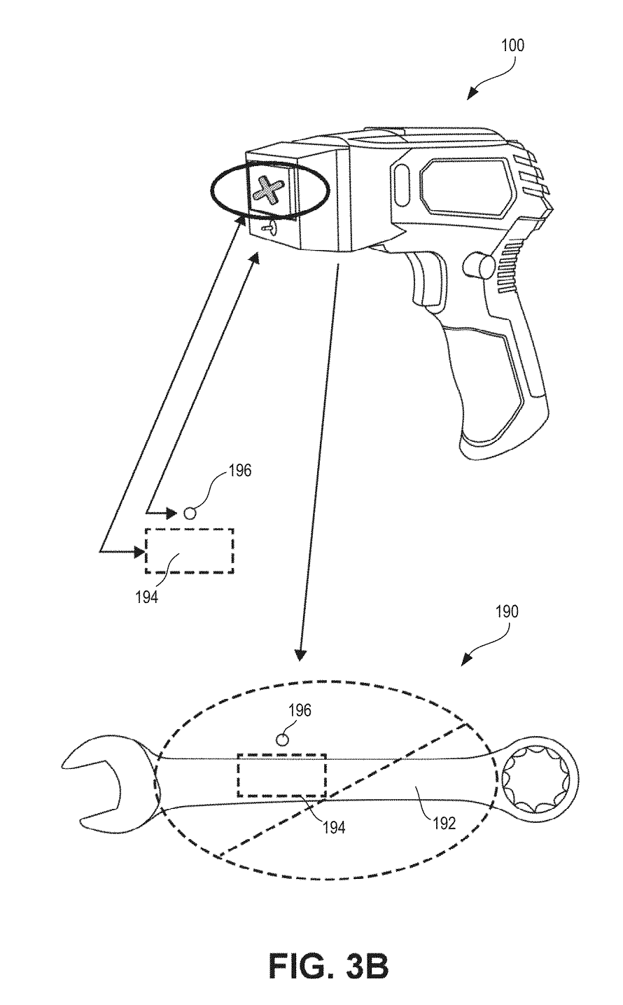

The electrical components 130 are generally retained within the housing 110 and include a current controller 132, a marker electrode 134, and a target surface connector 136. The current controller 132 is configured to be connected with a power source, such as an alternating current power supply or battery as described below with reference to FIGS. 7 and 9-12. The marker electrode 134 is connected to the current controller 132, as indicated by the dotted lines in FIGS. 2A and 2B. The marker electrode 134 is attached within the distal end 112 of the housing 110, and is electrically connected to the pad 152. Although the marker electrode 134 is shown as including a protrusion, the marker electrode 134 can have any suitable shape and/or size. For example, in some embodiments, the marker electrode 134 can be a rectangular, flat electrode that corresponds to the shape and size of the pad 152. The target surface connector 136 is disposed on the distal end 112 of the housing and is configured to be electrically connected with the surface 192 to be marked (e.g., at the location 196 as shown in FIG. 3A). The target connector 136 is also is connected to the current controller 132, as indicated by the dotted lines in FIGS. 2A and 2B. Thus, when the marker device 100 is placed in contact with the object 190 to be marked, the user can activate the actuator/trigger 116, which activates the current controller 132 to provide electric current between the marker electrode 134 and the target surface connector 136 through the target surface 192 of the object to be market. In some embodiments, the actuator 116 can actuate the delivery of electrolytic fluid 154 along with actuating electric current for electrochemical marking operations, similar to the device shown and described below with reference to FIGS. 9-11.

The target surface connector 136 is shown in FIG. 2B and includes a base post 138 and a tip 140. In some embodiments, the target surface connector 136 can include a spring or other biasing member (not shown) within the base post 138, which can allow the tip 140 to be biased against the surface 192 of the object to be marked during marking operations. In this manner, the tip 140 can be maintained in contact with the surface 192. Alternatively, a slide (not shown) can be connected to the tip 140 and can be disposed along an exterior portion of the housing 110, which can allow the tip to be extended and retracted by the user as needed for electrically contacting the surface 192 to be marked during use.

The marker assembly 150 is attached to the distal end 112 of the housing 110 and includes a cover 158, a pad 152, an insulated frame 168, a conductive base 170, and a conductive spacer 172. The pad 152 is configured to (or is constructed from a material formulated to) retain electrolytic fluid 154 therein (see e.g., FIG. 2B). The pad 152 is electrically connected to the marker electrode 134 via the conductive base 170 and the conductive spacer 172 so that an electric current can flow from the marker electrode 134 through the electrolytic fluid 154 in the pad during marking operations. Although the marker electrode 134 is shown as being electrically connected via the conductive base 170 and the conductive spacer 172, in other embodiments, the marker assembly need not include either the conductive base 170 or the conductive spacer 172. The pad itself can be conductive or semi-conductive, but does not need to be conductive due to the electrical connection being formed primarily through the electrolytic fluid during electrochemical marking operations. The pad 152 can be can be formed from a variety of materials and structural arrangements of materials to have provide many different advantageous properties for retaining the electrolytic fluid and for controlling the flow of the electrolytic fluid 134. The properties of the pad 152 can be configured based, in part, on properties of the electrolytic fluid, such as viscosity of the electrolytic fluid, the conductivity of the electrolytic fluid, or other properties. For instance, the pad 152 can be formed from fibrous or sponge-like materials made from polymers, fiberglass materials and the like and can be configured to have various properties related to stiffness, fluid retention, fluid permeability and the like.

The cover 158 is removably attached to the housing 110 and the marker assembly 150, which allows the cover to be removed and attached as desired so that the pad 152 can be replaced as needed, and to permit an insulated stencil 160 to be installed and replaced in the marker assembly 150 for creating various types of marks. When the marker assembly 150 is assembled and attached on the distal end 112 of the housing 110, the cover 158 retains the insulated stencil 160 to an outer surface 156 of the pad. The insulated stencil 160 defines at least one permeable portion 162 therein that is formed in the shape or pattern of the desired mark to be placed on the object. A contact portion 157 (see FIGS. 2A and 3A) on the outer surface 156 of the pad 152 contacts or adjoins the at least one permeable portion 162 when the cover 158 retains the insulated stencil 160 to the outer surface of the pad.

As is also shown in FIG. 2B, the cover 158 further prevents inadvertent electrical connections from forming except through the at least one permeable portion 162 by enclosing the insulated stencil 160 and the pad 152 within the insulated cover. The cover 158 is formed from an insulated material, such as an insulated plastic material, a polymer, a fiberglass material and the like. The cover 158 includes sidewalls and a distal end that encloses the insulated stencil 160 and pad 152 therein except for openings defined in the cover that are beneficial for electrochemical marking operations. Specifically, the cover 158 defines a cover opening 164 through the cover at its outer, distal end, through which the outer surface 163 of the stencil is exposed along with the at least one permeable portion 162 of the insulated stencil 160. The cover 158 further defines an optional target surface connector opening 166 at its outer, distal end, through which a tip 140 of the target surface connector 136 can extend.

The insulated stencil 160 is configured as a thin, conductive sheet 160 that limits electrical connection therethrough, except through at least one permeable portion (or opening) formed in the insulated stencil 160. As such, the insulated stencil 160 can control the flow of electric current to only flow through the stencil during electrochemical marking operations along the at least one permeable portion of the stencil. Such an arrangement of the insulated stencil 160 on the marker device 100 that limits electric current to only flow through it along the at least one permeable portion 162, in combination with the pad 152 that is configured to retain and control the flow of the electrolytic fluid through the pad, allows the integrated marker device 100 to perform high quality electrochemical marking operations on a target surface 192 to a place a desired mark in the target surface without needing to attach a stencil or protective mask to the object to be marked.

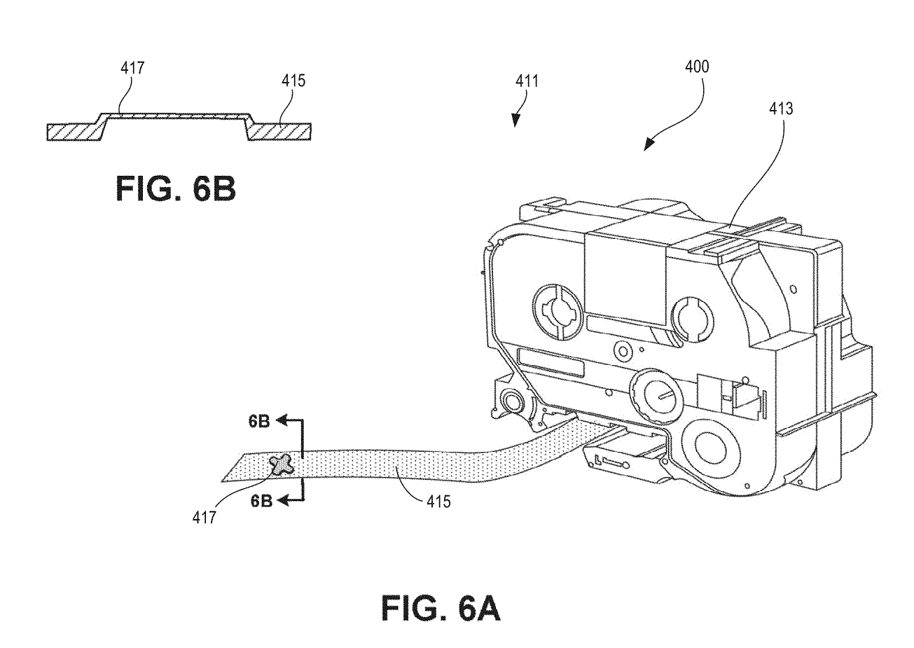

The at least one permeable portion 162 can be formed as at least one portion that is permeable with respect to electrolytic fluid 154 and/or that is permeable (i.e., electrically conductive) versus other portions of the insulated stencil 160. For example, in some embodiments, insulated stencil 160 can be formed from a sheet of thin, non-conductive polymeric material and the at least one permeable portion 162 can be formed as a shape that is punched or pressed to deform the sheet in that area and make it permeable or semi-conductive, such as by thinning the sheet (see e.g., FIGS. 6A & 6B). When the thin polymeric material is deformed, the properties of the deformed area can change such that sheet can become conductive in the deformed area and/or can permit electrolytic fluid 154 to permeate through the sheet in the deformed area.

In some configurations, the at least one permeable portion 162 can be formed as at least one stencil opening defined through the insulated stencil. For example, the insulated stencil 160 can be formed from a thin sheet of insulated material, such as a polymeric material, and the at least one stencil opening 162 can be defined through the stencil in a configuration and shape that correspond with the desired mark to be placed on (or in) the target surface. The at least one stencil opening 162 can be formed by cutting, punching or otherwise removing material from the sheet in the area of the at least one stencil opening. In another example, the insulated stencil 160 can be formed as a molded thermoplastic stencil that is molded in a desired configuration that defines the at least one stencil opening 162 through the stencil. Further, in some embodiments, a set of pre-formed stencils 160 can be provided for use with marker device 100, such as stencil kit (not shown) that includes a plurality of stencils having various pre-formed openings 162 defined therein (e.g., letters, numbers, common shapes and the like). In another example, stencil 160 can be made from curable polymer or another curable film that can be screen printed or otherwise created to have the desired shape defined through the film to form the at least one opening 162. The curable polymer can include rapidly curable polymers, such ultraviolet light curable polymers or heat-curable polymers.

When the at least one permeable portion 162 includes or is defined as opening through the stencil 160, the contact portion 157 of the outer surface 156 of the pad 152 can extend into and be disposed within the at least one opening when the cover 158 installed with the insulated stencil 160 on the marker assembly 150. In such an arrangement, the contact portion 157 of the outer surface 156 can be disposed generally parallel with the outer surface 163 of the stencil. In some configurations, the marker assembly 150 can be configured so that the contact portion 157 of the outer surface 156 of the pad 152 extends through and is disposed distally beyond the outer surface 163 of the stencil. For example, the contact portion of the outer surface 156 of the pad 152 can extend beyond the outer surface 163 of the stencil to be proud of the outer surface, such as to be proud by a height of about 0.5 mm, 10 mm or more.

Configuring the contact portion 157 to be at least parallel with an outer surface 163 of the stencil can permit a good electrical connection to be formed between the contact portion 157 and the surface 192 to be marked. Configuring the contact portion 157 to extend beyond and proud of the outer surface 163 of the stencil can further improve the electrical connection to be formed with the surface to be marked. In another example, the contact portion 157 of the outer surface 156 of the pad 152 can extend through the cover opening 164 to extend beyond the distal outermost surface 159 of the cover 158 to further enhance the electrical connection to be formed. In some embodiments, the contact portion 157 of the pad 152 and the outer surface 163 of the stencil 160 can extend distally beyond the outer surface 159 by a distance of about 0.5 mm, 1.0 mm or more. Enhancing the electrical connection to be formed during electrochemical marking operations can improve the depth, height, and quality of the mark that is placed on (or in) the target surface 192.

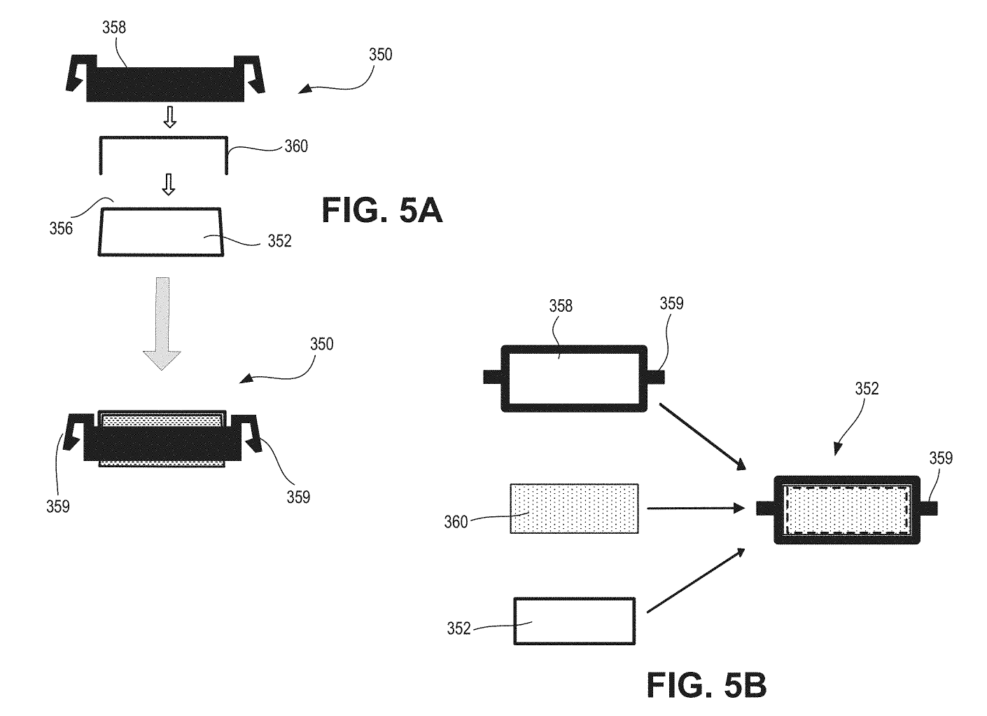

As further shown in FIG. 2B, the marker assembly 150 can include additional features and components that can enhance its structural integrity, improve electrical connections required for electrochemical marking operations, better isolate electric paths (e.g., the electrode path vs. the target surface connector), and allow the cover 158 to be quickly removed and installed during use. Easy removal and installation of the cover 158 can allow the insulated stencil 160 to be readily swapped as needed for applying various different marks. In addition, easy removal and installation of the cover 158 can permit the pad 152 to be replaced between marking operations as needed, and can allow electrolytic fluid 154 to be manually added to the pad 152. Various features and options for retaining the cover 158 and allowing for its easy removal and installation are discussed in greater detail below, such along with the schematic marker assembly shown in FIG. 5B.

Other additional features and components of the marker assembly 150 as shown in FIG. 2B include a conductive support frame 174, a conductive spacer 172, and a conductive frame 170. The support frame 174 is mounted on (or formed as a part of) the distal end 112 of the housing 110, which is electrically connected to the electrode 134. The conductive frame 174 provides a rigid platform for the marker assembly 150 or to which the marker assembly can be coupled. The conductive frame 174 further allows the electrode 134 to be securely attached to the marker assembly and provides for a robust electrical connection to be made between the electrode 134 and other components of the marker assembly 150, such as the contact portion 157. The conductive spacer 172 is retained on a distal end of the conductive frame 174, and provides a large electrically conductive support face for the electrical connection between the electrode 134 and remaining components of the marker assembly 150. The conductive base 170 covers the conductive spacer 172 and extends over side portions of the conductive frame 174.

In such an arrangement, the outer surface of the conductive base 170 provides a large, electrically conductive, contact surface to support the pad 152 in the marker assembly 150. As such, the conductive base 170 is arranged to firmly support the pad 152 and to provide a robust electrical connection between the pad 152 and the electrode 134 along its entire inner side. Such a configuration of the additional components of the marker assembly allow a robust electrical connection to be made with the electrode 134 through the electrolytic fluid 154 when the fluid is retained in the pad 152. These additional electrically conductive components (i.e., the support frame 174, the spacer 172 and the base 170) can be formed from conductive metal materials, such as copper, aluminum, zinc, iron, nickel, platinum and/or from conductive alloys.

Referring to FIG. 2B, the insulated frame 168 is disposed around side portions of the conductive electrically conductive components described above (e.g., the conductive base 170 and the support frame 174). The insulated frame 168 forms a protective (or insulative) barrier between the conductive proximal components and the target surface connector 136 that is located proximate the marker assembly 150, and is disposed within a portion of the removable cover 158. Thus, the insulated frame 168 can prevent inadvertent electrical contact from occurring between the conductive proximal components that are electrically connected to the electrode 134 and the target surface connector 136, and/or with the object 190 to be marked. The insulated frame 168 can be made from a rigid insulating material such as fiberglass or a plastic insulating material, such as polyurethane or poly-vinyl chloride (PVC). A distal end of the insulated frame 168 defines a distal opening over which the insulating stencil 160 is disposed when retained in the marker assembly 150 by the cover 158. The distal opening in the insulated frame 168 allows a contact portion 157 of the pad 152 to extend through the distal opening. As such, the stencil 160 can be placed against an outer surface 156 of the pad 152 that extends through the distal opening of the insulated frame 168. Such an arrangement allows the contact portion 157 of the outer surface 156 of the pad 152 to adjoin the at least one permeable portion 162 or extend into and/or through the at least one openings 162 formed through the insulated stencil 160 in the assembled condition to form a robust electrical connection through the distal opening while also protecting against inadvertent electrical connections being formed.

FIG. 3A shows an example arrangement for applying a mark in a surface 192 of the example object 190. The example includes marking with an insulating stencil 160 that has been installed within the marker assembly 150, and that defines at least one opening 162 formed through the stencil. In the example shown in FIG. 3A, the at least one opening 162 outlines a pattern for the mark that is generally shaped as an “X.” As further shown, a corresponding “X” shaped contact portion 157 of the outer surface 156 of the pad 152 extends into the at least one opening 162, and also extends beyond the outer surface 163 of the stencil and beyond a distal end of the removable cover 158. In use, the user can add electrolytic fluid 154 to the pad 152 by any suitable method (e.g., via manually applying droplets of the electrolytic fluid 154 to the pad, by actuating a reservoir of electrolytic fluid, or the like). As described above, the pad is formulated to and retains sufficient electrolytic fluid for applying a mark on object 190. Accordingly, when the current controller 132 is electrically connected to a power source (not shown), and when the device is actuated by the user (e.g., via the actuator 116), the current controller 132 provides electric current from the electrode 134 through the object 190 to the electrode 136.

In the example arrangement shown in FIG. 3A, the integrated marker device 100 allows a user to form a mark on a surface 192 of object 190 quickly and easily without needing to assemble the object 190 within a fixture, affix a mask to object 190, attach wires or ground connections to the object 190, and without needing to perform complex laboratory-type procedures. Rather, the user can simply move the distal end of the marker device 100 against the surface 192 of the object such that “X” shaped contact portion 157 of the outer surface 156 of the pad 152 contacts the surface 192 to be marked and, if desired, such that the outer surface 163 contacts the surface 192 along region 194 of object 190. While in such a position, the tip 140 of the target surface connector 136 is in contact against the surface 192 at location 196. Thus, a robust electrical connection is formed between the target surface connector 136 against the surface 192, and between the electrolyte 154 within the pad 152 in the “X” shaped contact portion 157 disposed against the surface 192. Further, the electrolyte 154 is controlled by the marker device 100 to be limited to the desired “X” pattern defined through the insulated stencil 152. Thus, the user merely needs to actuate the actuator 116 to activate electrical current to flow through the object 192 in the desired “X” shaped pattern of the contact portion 157, and to thereby to mark a corresponding “X” shaped mark in the surface 192, such as etching the “X” shaped marking in the surface 192.

Referring now to FIG. 3B, another example arrangement is shown for forming a mark in or on a surface 192 of the example object 190. The example shown in FIG. 3B is generally the same as is shown in FIG. 3A except that the orientation of the object 190 to be marked has been rotated by 90 degrees relative to the marker assembly 150. As such, even though the distal end of marker device 100 can be placed against surface 192 at region 194, the tip 140 of the target surface connector 136 may not be placed in an electrical connection with the surface of the object to be marked (e.g., if the object 190 is too small). The object 190 is therefore unable to be marked according to the procedure described above with reference to FIG. 3A. Although the example object 190 could be rotated to proceed with marking the target surface (in a manner similar to that described above with reference to FIG. 3A), this may not be desirable. Additionally, there may be other instances in which the marker device 100 may not easily form a suitable electrical connection between the object 190 and the target surface connector 136. Thus, in some embodiments, the marker device 100 (and any of the marker devices shown herein) can include other target surface connector configurations that facilitate marking a variety of different objects.

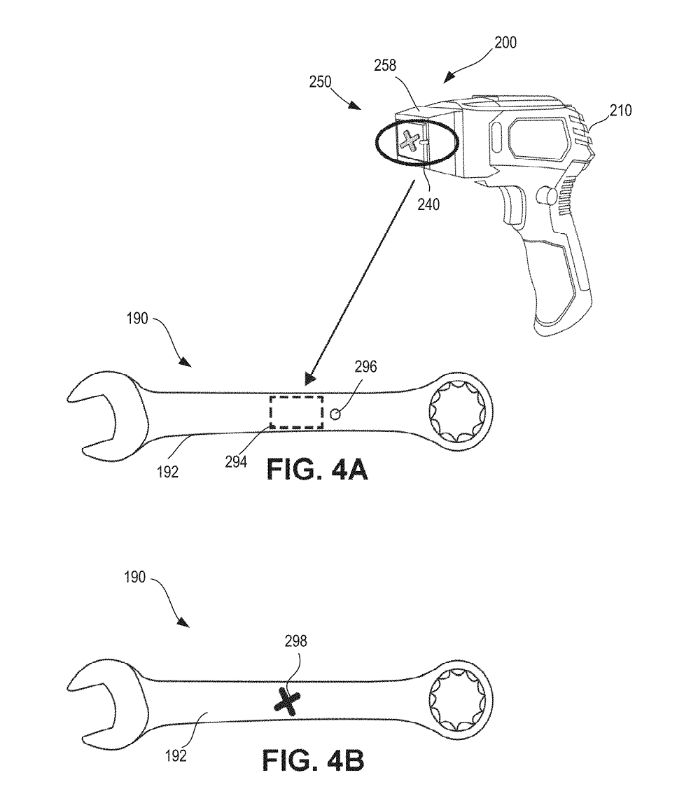

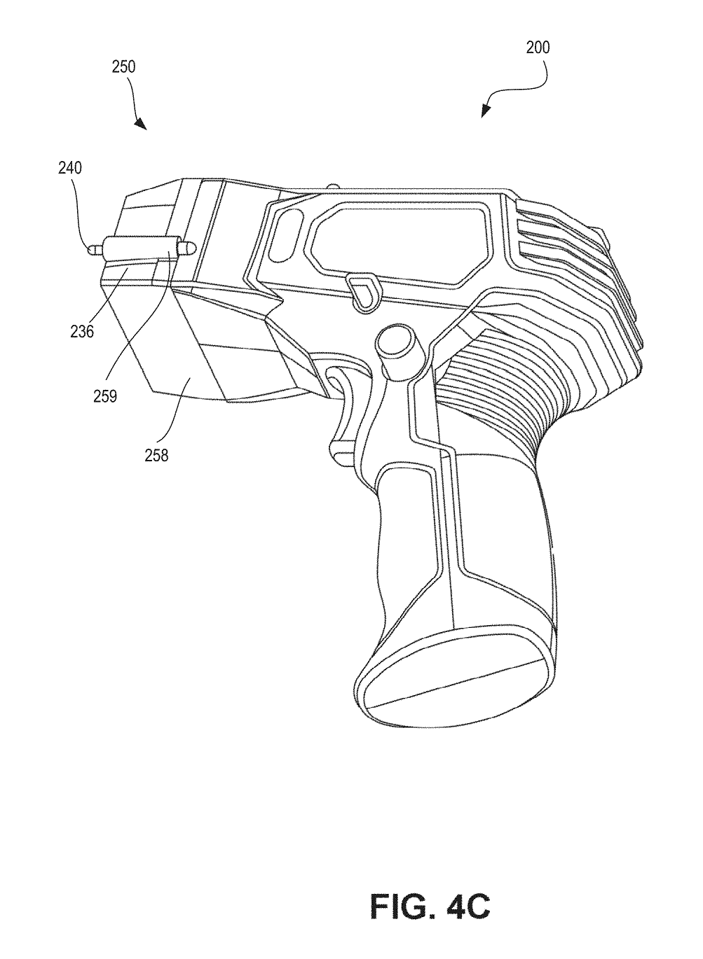

As one example, FIGS. 4A-4C show a marker device 200 that includes a side-mounted ground connection that can be used to mark a long, narrow object in the orientation shown in FIG. 3B. Thus, the marker device 200 includes various additional options for the orientation, placement and configuration of its target surface connector. The marker device 200 generally includes the same aspects, preferences and features described above for the marker device 100 except as discussed herein regarding the target surface connector and regarding attachment features for the removable cover. Specifically, the marker device 200 differs from the marker device 100 in that it includes a target surface connector 236 (see FIG. 4C) disposed at a different location with respect to the removable cover 258. Similar to the target surface connector 136, the target surface connector 236 includes a distal tip 240 that extends through a cover opening (not shown) formed through a distal surface of the removable cover 258. However, in contrast to the target surface connector 136, the target surface connector 236 is disposed on a lateral, side region of removable cover 258 that is oriented about 90 degrees from the location of target surface connector 136. Further, an attachment bolt 259 is shown in FIG. 4C, which securely and removably attaches the removable cover 258 to the housing 210.

Although shown as including a side-mounted target surface connector, the marker device 200 can include accessories and components to enhance its ease of use and its flexibility for use with objects of various shapes, types, arrangements, surfaces, etc. In the example shown in FIGS. 4A, 4B and 4C, the removable cover 158 has been removed and replaced by another removable cover 258 that has the target surface connector 236 disposed at a more suitable location for the particular use. Other removable covers (not shown) can also be provided that have target surface connectors disposed in even more optional locations. For example, in some embodiments, a kit can include a set of covers having target surface connectors coupled thereto in different orientations. Moreover, in yet other embodiments, any of the marker assemblies described herein can have multiple target surface connectors that are selectively coupled to the current controller. In this manner, a different cover (or marker assembly) need not be used, but rather, the user can select one of any number of different target surface connectors to be activated.

Further, as shown in FIGS. 9, 12 and 20, in some embodiments, a marker device can include a removable target surface connector (not shown), such as a clip-type connector, which can provide further options for quickly establishing a ground connection with the surface of an object to be marked.

In addition to providing an alternative location for the target surface connector, the marker device 200 also illustrates another example type of connection for the removable cover 258 that can be used with integrated marker devices. Specifically, as shown in FIG. 4C, the marker device 200 includes a removable bolt connector 259 that provides a secure, threaded connection for retaining the cover 258 on the marker device. As shown, the bolt connector 259 can be co-located with a target surface connector that is arranged to extend from the distal end of the cover. However, it is understood that threaded connections for the removable cover can be located at various locations around the cover and can include one or multiple threaded connections—either alone or in combination with other retention features like one or more clips. Further, it is understood that other types of connections for the removable cover can be provided for retaining the cover while also allowing it to be quickly and easily removed and installed to change the configuration of the marker device, such as replacing the pad or swapping the stencil.

For example, FIGS. 5A and 5B show a marker assembly 350 that can be used with the marker devices 100 and 200 discussed above, as well as with other configurations and arrangements of marker devices described herein. Marker assembly 350 generally includes the same aspects and preferences as marker assembly 150 discussed above along with FIGS. 1-3B except as discussed below. Specifically, the marker assembly 350 is shown in schematic form in FIGS. 5A and 5B to illustrate various advantageous features for coupling the cover to the housing, as discussed below, without limiting these features unnecessarily to any particular arrangement or configuration for the marker assembly.

As shown, the marker assembly 350 includes a pad 352 and a cover 358 that retains a stencil 360 to the pad 352. As described above, the pad 352 can be any suitable pad that retains an electrolytic fluid and is in removable contact with the stencil 360. More specifically, FIGS. 5A and 5B show that the cover 358 can be assembled to retain an inner surface of the stencil 360 to an outer surface 356 of the pad 352 and laterally encloses the stencil 360. As discussed above, the removable cover 358 is formed from a non-conductive material that prevents inadvertent electrical connections between the pad retaining the electrolytic fluid and the target surface connector or other components.

The removable cover 358 includes one or more fasteners 359 for quickly and easily removing and installing the cover 358 in an assembly with the stencil 360 and the pad 352. Fasteners 359 include a pair of flexible snap connectors 359 having inner hook surfaces. The snap connectors 359 allow the user to push the cover 358 firmly over the pad 352 and stencil 360 until it snaps into its assembled position (e.g., about mating fasteners on a device housing, not shown). This allows the user to apply force on the assembly without having to manage a connection feature simultaneously. This arrangement helps the user focus on applying force to the assembly and ensure a contact portion of the outer surface of pad 360 is forced against the at least one permeable portion of the stencil 360 or into the at least one opening of the stencil 360. Further, the user can easily flex outward the flexible features 359 to disengage the snaps and remove the cover 358 from the assembly.

It is understood that the schematic representation of FIGS. 5A and 5B are only general representations for illustrating the features described. It is understood that many different and various types of arrangements and configurations can be used for the illustrated assembly including many different types of quickly releasable and quickly connectable retention mechanisms. For instance, more or less than two quick connectors could be included to retain the assembly, which can be placed at various locations on the cover 358 and/or on other components. Further, many different types of quick connections could be used and could be combined with other features, such as a combination hinge and snap arrangement, rotatable or removable snaps or clips, movable lock features, threaded connections, etc.

Referring now to FIGS. 6A and 6B, a stencil dispenser 400 is generally shown that can be used to form an insulated stencil, such as the insulated stencil 160 described above along with the marker device 100, or any other stencils described herein. Stencil dispenser 400 generally includes a stencil maker 411, a stencil dispenser 413 retained within the stencil maker, and a store of stencil tape 415. The stencil dispenser 413 in the configuration shown is arranged as a cartridge 413 that is removable and replaceable within the stencil maker. The stencil dispenser 413 is pre-loaded with a store of insulated stencil tape 415, such as a roll of polymeric tape. The stencil dispenser 413 is configured to dispense the stencil tape 415 from the store of stencil tape as needed along with the stencil maker performing stencil-making operations. The stencil-making operations can include, for example, the stencil maker punching and/or cutting selected shapes, letters, numbers, characters or other patterns into or through the stencil tape. The selected patterns can be selected by the user from a selection of pre-determined shapes, for which preformed punches or cutting features (not shown) have been provided. Further, the user can provide custom-designed punches or cutting features for use with stencil dispenser 400.

As shown in FIG. 6B, a permeable portion 417 can be formed in the stencil tape 415 as a raised, thinned portion in the tape. The punches or cutting features can punch a corresponding shape into the tape 415, which raises and permanently deforms the tape in the selected shape. The deformation of the tape can thin the tape 415 sufficiently to make the deformed region permeable with respect to electrolytic fluid and/or can reduce its insulating properties sufficiently to allow an electric current to arc through and flow through the deformed region. Alternatively, the punches or cutting features can completely cut through or punch out the corresponding shape and, thereby create an opening through the tape 415 in that shape.

It is understood that stencil dispenser 400 is merely an example technique for creating stencils. For example, in other embodiments, the stencil dispenser 400 could be configured to apply heat or light to the tape 415 in a selected shape, which could degrade, melt or modify the tape in the region of the shape to make it permeable or to be removed. In another example, stencil dispenser 400 could be arranged to retain the tape 415 in a fixture to allow the user to cut a desired pattern or shape in the tape 415. Other examples and options are also available as discussed above along with marker device 100, such as molding stencils having desired openings formed therein, screen printing a stencil film having a desired shape formed therein followed by curing the film, applying a chemical to a substrate in the form of a desired shape to create an opening or permeable area, etc.

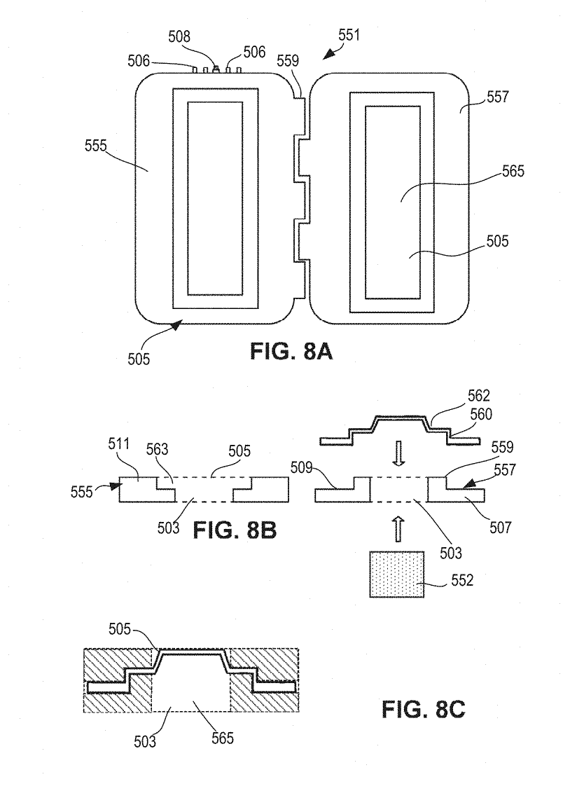

Although the cover 358 is shown as being a single-piece cover, in other embodiments, a cover can include any suitable structure to retain a stencil therein. For example, FIGS. 7, 8A and 8B show a marker device 500 that includes a stencil container 551. Marker device 500 generally includes the same aspects and features as marker devices 100 and 200 discussed above except with respect to a marker assembly 550 and a stencil container 551, and as discussed below. As shown, marker device 500 includes a housing 510, electrical components 530, and a marker assembly 550. Similar to marker devices 100 and 200, the housing 510 includes a distal end 512, a generally opposite handle portion 514, and an actuator 516. The handle portion 514 permits the user to manipulate the marker device 500 and place the distal end 512 proximate a surface of an object to be marked. The actuator 516 is arranged as a movable trigger 516 in the example shown so that the user can simply move the actuator to activate the marker device 500 for marker operations.

The electrical components (also referred to as the electrical assembly) 530 are generally retained within the housing 510 and include a current controller 532, an electrode 534, and a target surface connector 536. The current controller 532 is configured to be connected with an alternating current power source via power cord 582 in the configuration shown, but can also be configured to be used with a battery as described with reference to FIGS. 9-12 below. The electrode 534 is connected to the current controller 532 and is attached to the housing 510 at its distal end 512. The target surface connector 536 is disposed on the distal end 512 of the housing and is configured to be electrically connected with the surface to be marked. When the marker device 500 is placed in contact with the object, the user can activate the actuator/trigger 516, which activates the current controller 532 to provide electric current between the electrode 534 and the target surface connector 536 through the surface of the object. In some embodiments, the actuator 516 can actuate the delivery of electrolytic fluid along with actuating electric current for marking operations, similar to the actuator shown and described with reference to FIGS. 9-11.

As shown in FIG. 7, the marker assembly 550 is attached to the distal end 512 of the housing 510 and includes a marker platform 501 and a stencil container 551. The marker platform 501 is mounted on the distal end 512 of the housing and retains the stencil container 551, which is removably attached within the marker platform 501. The marker platform 501 includes a distal face 503 that is configured to be placed proximate a surface to be marked. Similar to the marker devices 100 and 200, the target surface connector 536 extends through an opening formed in the distal face 503 such that a tip 540 is configured to be placed into contact with a surface to be marked when marker assembly 550 is placed in position against the surface. Unlike the marker assembly 150 described above, however, the target surface connector 536 does not extend through an opening defined by the removable stencil container 551.

As best seen in FIGS. 8A-C, the removable stencil container 551 is generally arranged as clamshell-type container having a forward shell 555, a rear shell 557 and a hinge 559 disposed between the shells that enables rotational movement of the shells with respect to each other about the hinge. The shells 555 and 557 move between their closed configuration shown in FIG. 7, which is the configuration they are in while disposed within the marker assembly 550, and the open configuration as shown in FIG. 8A. Each of the shells 555 and 557 can be formed from a rigid insulated material to provide an insulated assembly, such as from an injection-molded polymer, a fiberglass material, and the like. The hinge 559 can also be formed from a similar insulated material to enhance the overall insulating properties of the container.

When in the closed configuration, such as when disposed within the marker assembly 550 as shown in FIG. 7, a pad channel 565 is defined through stencil container 551 that includes a housing opening 503 disposed near the distal end 512 of the housing 510, as well as an opposite stencil opening 505 disposed within the distal face 569 of the marker assembly 551. The housing opening 503 permits the electrode 534 disposed within the housing 512 to extend into the stencil container and electrically connect to the pad 552 disposed therein while the stencil container 551 is mounted in the marker assembly 550. As shown in FIG. 8B, housing opening 503 is formed in an outer face 507 of rear shell 557. A raised frame 559 is formed on the opposite inner face 509 of the rear shell 557, which extends around the perimeter of the pad channel 565. A frame recess 563 is formed on the inner face 511 of the forward shell 555, which corresponds with the shape of the raised frame 559 of the rear shell 557. However, a perimeter of the frame recess 563 is formed to be slightly larger than a perimeter of the corresponding raised frame 559 to permit the insulated stencil to be sandwiched between the raised frame 559 and the frame recess 563 while in the closed configuration.

The stencil container 551 can be easily removed and installed within the marker assembly 550 and can be easily opened and closed while out of the marker assembly 550. As such, the stencil container 551 provides an easy mechanism for quickly replacing the stencil 560 with another stencil, replacing the pad 552 and/or for adding electrolytic fluid to the pad directly. In one configuration, the stencil container 551 can be configured to simply slide rearward from the distal face 569 into a corresponding opening defined in the distal face 569 and formed within the marker assembly 550. The stencil can be retained within the stencil assembly 551 via a force fit with the stencil assembly or via geometric retention features (not shown) configured to engage side portions of the stencil container 551 when installed within the marker assembly 550. The stencil container 551 can also be retained within the stencil assembly via retention features, such as snaps, threaded connectors and other secure features (not shown) that can firmly retain the stencil container 551 within the marker assembly during electrochemical marking operations while also allowing for quick and easy removal and installation when needed.

As shown in FIG. 8A, the stencil container 551 can include guide marks 504 that are configured to extend from the stencil container and the marker assembly 550 to be viewable by the user during electrochemical marking operations. The marks 504 include a center mark 508 that identifies a center region of the contact portion 557 that contacts the target surface to apply the mark. The marks 504 further include side markings 506 disposed on each side of the center mark 508. The marks provide a guide for the user for aligning the marker assembly 550 in contact with the target surface at a desired location to apply (e.g., etch) the mark.

Referring now to FIGS. 9-11, a marker device 600 is shown that includes the aspects and features of marker devices 100, 200, and 500 except as discussed below. Marker device 600 includes a housing 610, electrical components (also referred to as an electrical assembly) 630, and a marker assembly 650. The housing 610 includes a distal end 612, a generally opposite handle portion 614, an on-board reservoir 623, and a dual action actuator 616. The handle portion 614 permits the user to manipulate the marker device 600 and place the distal end 612 proximate a surface of an object to be marked. The reservoir 623 disposed within the housing 610 and defines a volume within which the electrolytic fluid is contained. The reservoir is refillable and defines a fill port 627 at a top portion of the reservoir 623. A closable reservoir lid 629 is attached to the reservoir for providing access to the reservoir 623 during refilling and closing the fill port 627 to retain the electrolytic fluid within the reservoir at other times. The housing includes an openable cover 613 that covers the reservoir lid 629 along with covering an accessory storage space 615 formed within the housing. The accessory storage space 615 allows accessory to be stored therein, such as a flexible target surface connector 637 and a recharging power cord 682, as well as other items such as replacement pads 652 or additional stencils 660.

A distal end of the reservoir 623 is coupled to a valve 631 that is disposed near the distal end 612 of the housing and extends into the marker assembly 650 to contact the pad 652. The reservoir 623 is slidably retained within the housing so that it can be moved forward within the housing toward the marker assembly 650. As discussed further below, the actuator 616 is configured to move a fulcrum 641 attached to a rearward end 643 of the reservoir such that the fulcrum 641 drives the reservoir 623 forward toward marker assembly 650. When driven forward, the reservoir valve 631 opens and permits electrolytic fluid disposed within the reservoir to flow into the pad 652. The fluid can flow into the pad 652 via a wicking action in which the pad draws fluid into the pad via absorption when electrolytic fluid is used during marking operations or if the pad has dried out, such as may occur during storage and nonuse. In other configurations, the electrolytic fluid 639 stored within the reservoir 623 can be pressurized to enhance flow of the fluid through the valve 631 when the valve is opened.

As shown in FIG. 9, the valve 631 is a spring-loaded valve that is biased into a closed position unless forced open via operation of the actuator 616. The valve 631 includes a stop 635 that is slidably disposed within a valve channel 625. The valve channel 625 has a flow opening that is sized to have a width or diameter that is smaller than that of the stop 635. A biasing member 636, such as valve spring, biases the stop 635 into contact the flow opening, which closes the valve 631 and maintains the valve in the closed configuration in the absence of a valve opening force. When actuator 616 is actuated with sufficient force to overcome the closing force provided by the biasing member 636 and drive the reservoir 623 forward, the biasing member 636 is compressed such that the stop 635 withdraws from the flow opening and permits electrolytic fluid 639 to flow therethrough out of the reservoir and into the adjacent pad 652.

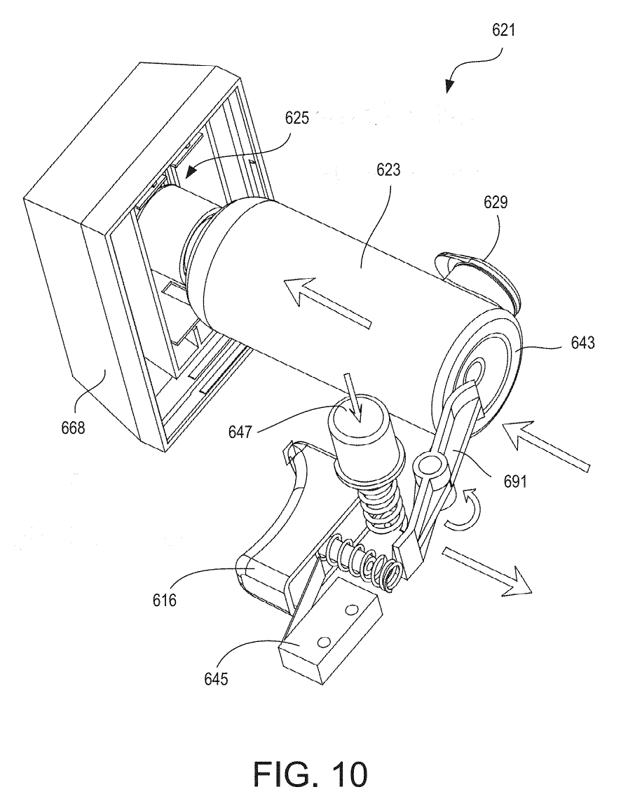

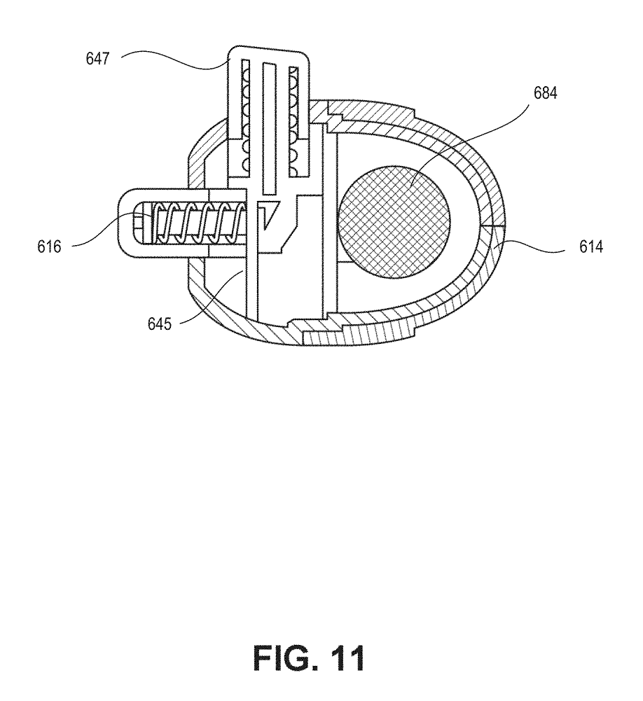

The actuator 616 is arranged as a dual action movable trigger 616. The dual action trigger 616 closes a switch 645 when initially moved rearward by the user, which activates the current controller to provide electrical current for marking operations. As the trigger 616 continues to be moved rearward by the user, the trigger 616 also drives the fulcrum 641 to drive the reservoir 623 forward to release the valve 631, as described above. As such, marking operations can begin via an electrical connection through electrolytic fluid initially retained in the pad 652. As the electrochemical marking continues beyond the initial activation of the switch 645, additional electrolytic fluid 639 disposed in the reservoir 623 is permitted to flow into the pad 652, as needed. Such a dual action trigger arrangement can be very beneficial when applying large marks into the surface of an object or when etching into hardened metals or other surfaces that can be difficult to create a mark in without performing extended marking operations. The user can choose whether to enable the dual action functionality of the trigger 616 by selectively moving a toggle 647 (see FIG. 10) into the dual action position. As shown in FIGS. 10 and 11, the toggle 647 can be biased to provide only single actuation by the trigger 616 to close the switch 645 without opening the valve 631. Thus, the user can actuate the dual action functionality of the actuator 616 only as necessary, such as for difficult, large or prolonged marking operations.

As discussed above along with the accessory storage space 615 shown in FIG. 9, the marker device 600 includes a flexible target surface connector 637 that can be attached when needed for marking operations. The flexible target surface connector 637 can be configured for as-needed installation, such as via a plug in connection formed in the housing 610 that allows the flexible target surface connector 637 to be quickly connected when needed for connecting to the surface of objects to be marked that may have odd shapes or arrangements that make it difficult for a target surface connector (e.g., similar to the target surface connector 136 described above) disposed at the distal end of the marker device to electrically connect with the surface appropriately. Alternatively, the marker device 600 can be configured to use only the flexible connector 637 without including any fixed target surface connectors. Such an arrangement can be beneficial for ensuring an enhanced grounding connection is formed when using the marker assembly 600, which may be configured as a heavy-duty marker device that operates at higher voltage and/or current levels than other marker devices, such as marker devices 100, 200 and 500. Similarly, the on-board electrolytic container 623, dual action actuator 616 and electrolytic fluid release valve 631 in combination with a higher rated, improved ground connection can cooperate to provide a high-performance, heavy duty configuration for the marker device 600.

In addition, marker device 600 includes an on-board rechargeable battery 684 along with recharging cord 682 that was noted above along with the accessory storage container. The use of an on-board rechargeable battery can alone provide many additional advantages for marker device 600, as well as even more benefits when combined with other features provided in the configuration of marker device 600. For instance, the rechargeable battery arrangement provides much greater portability advantages for the marker assembly 600, in that it can be used away from an alternating-current power source and without being limited by the length of a cord or the proximity of the power source to the object to be marked. In addition, having an on-board rechargeable battery power source allows much more flexibility for using the marker assembly in a variety of orientations, such as for marking on an object that is installed on a structure or located in an orientation that would be difficult to access if limited to usage with an AC power cord connected.

Further, rechargeable battery power sources are more efficient in that losses related to rectifying alternating current to produce necessary direct current for certain marking operations can be avoided. Further, an on-board direct current power supply from a battery can provide greater short term power output at much higher voltages and/or amperes than can be provided from a typical alternating current electrical outlet that provides 110/120 V output up to 20 amps (i.e., 2.4 kW ignoring any peak fluctuations). In some situations, it can be difficult to mark various types of metals or metal objects, and proceeding without sufficient power can result in poor quality markings that are pitted or not well formed. As such, it can be advantageous to provide a rechargeable battery power source for a marking device 600.

Although the marker device 600 is shown and described as including a reservoir 623 within the housing 610, in other embodiments, any of the marker devices described herein can include any suitable reservoir for containing the electrolytic fluid. For example, in some embodiments, a marker device can include a reservoir that is fixed within (i.e., does not move within) a housing. In such embodiments, the electrolytic fluid can be conveyed from the reservoir without movement of the reservoir. In other embodiments, a marker device can include a reservoir coupled to and maintained outside of the housing. For example, FIG. 12 shows a marker device 700 that generally includes the aspects and features discussed above along with marker devices 100, 200, 500 and 600 except as discussed herein. Similar to the marker device 600, the marker device 700 includes a housing 710 having a distal end 712 that also includes an electrolytic fluid reservoir 723 attached to the housing with a dispenser opening located at the distal end 712 of the housing 710. However, electrolytic reservoir 723 is attached to the housing as an external reservoir that is not retained within the housing. Instead, external reservoir 723 has a threaded connection with the housing 710 at its opening at the top of the reservoir. As such, the electrolytic reservoir can be easily removed from the marker device 700 to refill the reservoir. In addition, reservoir 723 is configured to be at least somewhat transparent, which allows the user to readily identify when the reservoir is low or needs to be refilled. In addition, reservoir 723 connects to a manual pump 731 that has a pump button 741 disposed on a top portion of the housing 710. Such a configuration provides the benefit of allowing a user to pump electrolytic fluid to the pad 752 prior to actuating the actuator 716 and activating the flow of current through the pad 752 that may not otherwise have sufficient electrolytic fluid retained therein to enable electrochemical marking operations to properly occur.

Marker device 700 includes a dual target surface connector arrangement that includes a target surface connector 736 extending from the distal end of the housing 712 and providing a tip 740 at the distal end of the marker assembly 750. In addition, similar to marker device 600, marker device 700 also includes a flexible target surface connector 737 that is formed from a removable clip connector attached to a flexible cord configured to electrically connect with the current connector disposed within housing 712. As described along with the marker device 600, such an arrangement provides advantageous options for establishing the ground connection including use of the flexible target surface connector 737 for difficult to reach or heavy duty electrochemical marking operations.

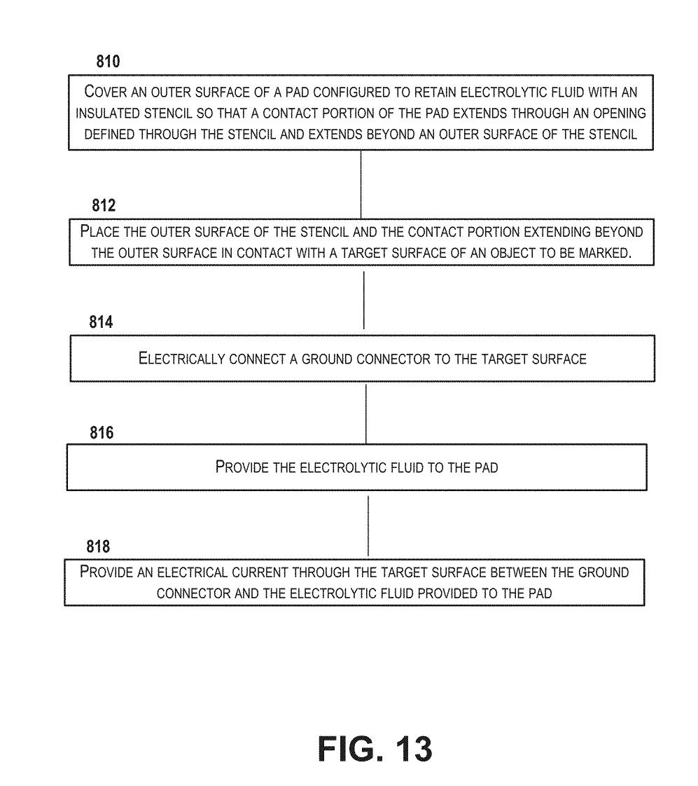

In some embodiments, a method for electrochemical marking on a target surface includes covering an outer surface of a pad configured to retain an electrolytic fluid with an insulated stencil so that a contact portion of the pad extends through an opening defined in the stencil beyond an outer surface of the insulated stencil, placing the contact portion in contact with the target surface, electrically connecting a ground to the target surface, and providing an electrical current through the contact portion of the pad and the target surface to the ground. Such methods can be performed using any of the marker devices described herein. FIG. 13 is a flow chart of a method 800 of electrochemical marking a target surface according to an embodiment. Although the method 800 is described in conjunction with the marker device 100 shown and described above, in other embodiments, the method 800 can be performed using any suitable marker device.

The method includes covering an outer surface of a pad configured to retain an electrolytic fluid (e.g., the outer surface 156 of the pad 152) with an insulated stencil (e.g., the stencil 160) so that a contact portion of the pad extends through at least one opening defined through the insulated stencil (e.g., the at least one opening 162) and extends beyond an outer surface of the insulated stencil, at 810. The method further includes placing the outer surface of the stencil (e.g., the outer surface 162 of the stencil 160) and the contact portion extending beyond the outer surface of the insulated stencil in contact with a target surface of an object to be marked (e.g., the target surface 192 of the object 190), at 812. The method also includes electrically connecting a target surface connector (e.g., the target surface connector 136) to the target surface, at 814. Further, the method includes providing the electrolytic fluid to the pad, at 816. Also, the method includes providing an electrical current through the target surface between the target surface connector and the electrolytic fluid provided to the pad, such as by actuating the current controller (e.g., the current controller 132), at 818.

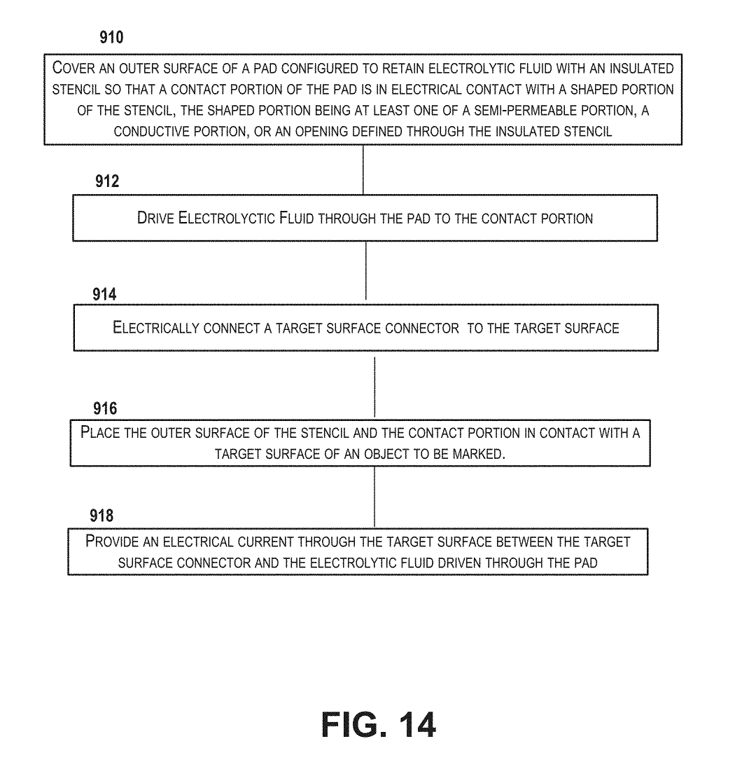

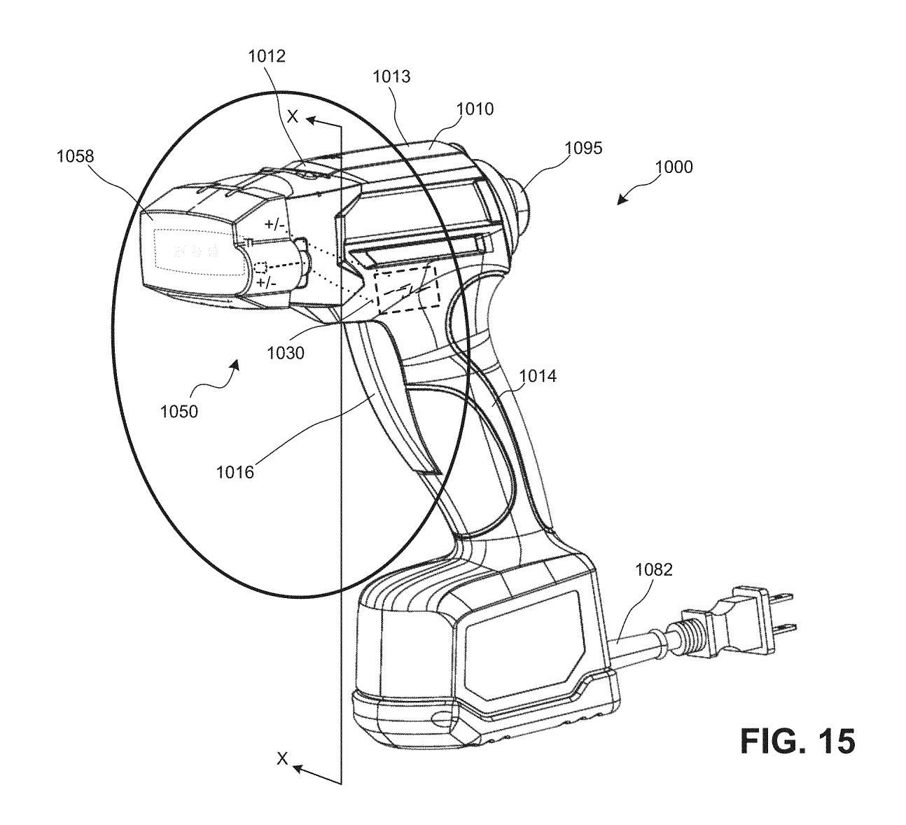

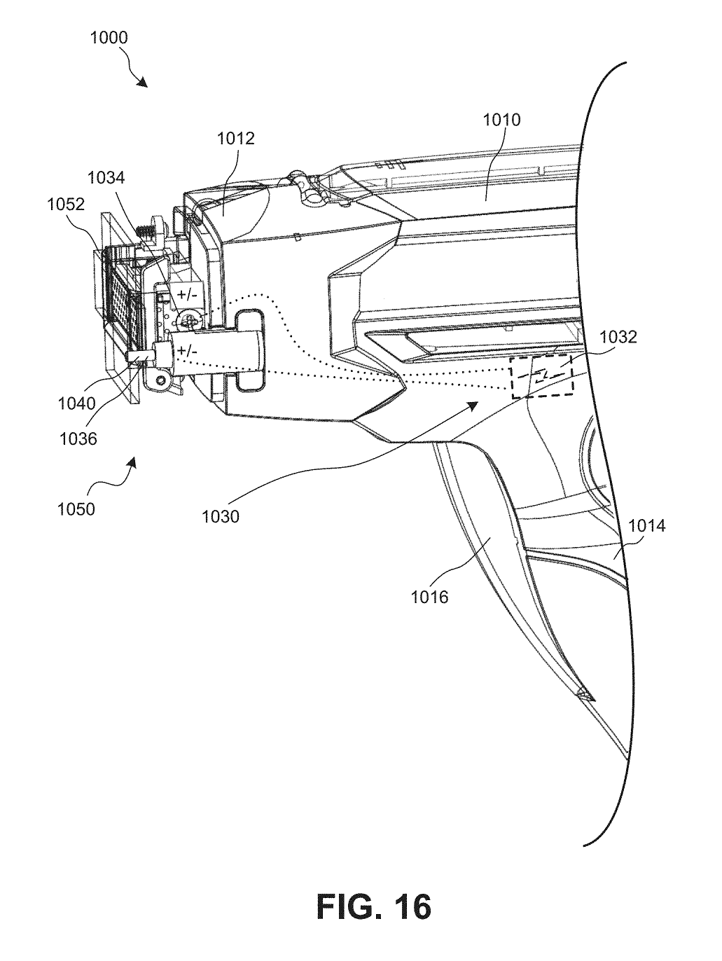

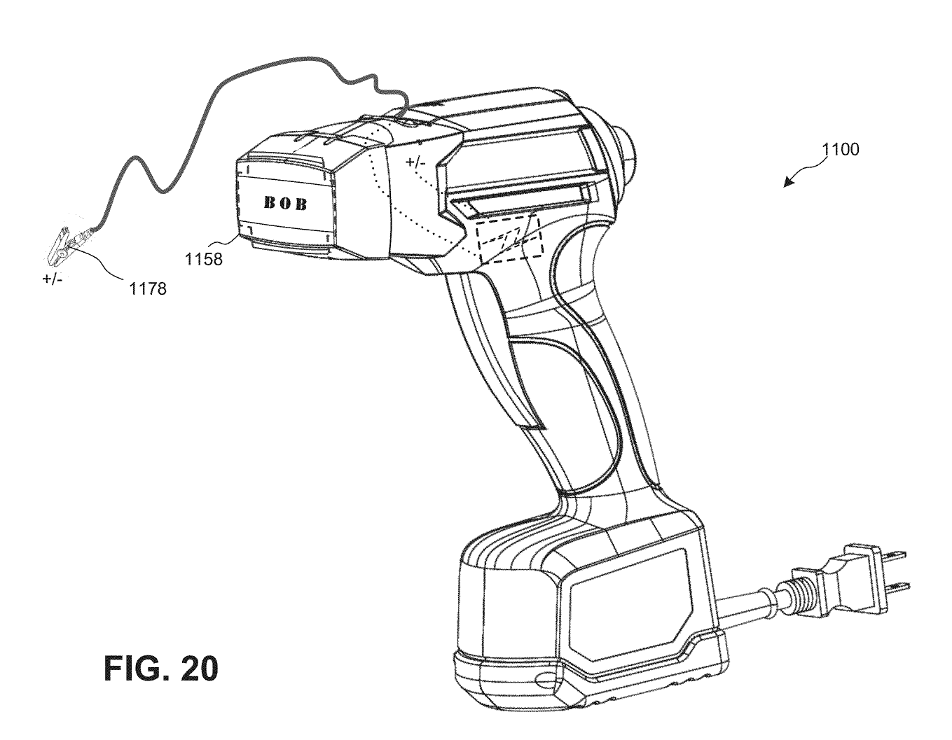

In some embodiments, a method for electrochemically marking a target surface includes covering an outer surface of a pad configured to retain an electrolytic fluid with an insulated stencil so that a contact portion of the pad is in electrical contact with a shaped portion of the insulated stencil. The shaped portion can be at least one of a semi-permeable portion, a conductive portion, or an opening defined through the insulated stencil. The method further includes driving the electrolytic fluid through the pad to the contact portion, electrically connecting a target surface connector to a target surface of an object to be marked, placing the outer surface of the stencil and the contact portion in contact with the target surface, and providing an electrical current through the target surface between the target surface connector and the electrolytic fluid driven through the pad. Such methods can be performed using any of the marker devices described herein. FIG. 14 is a flow chart of a method 900 of electrochemically marking a target surface according to an embodiment. Although the method 900 is described in conjunction with the marker device 100 shown and described above, in other embodiments, the method 900 can be performed using any suitable marker device including, for instance, marker devices 1000 and 1100 described below and generally shown in FIGS. 15-19 (marker device 1000) and FIG. 20 (marker device 1100).

The method 900 includes covering an outer surface of a pad configured to retain an electrolytic fluid with an insulated stencil so that a contact portion of the pad is in electrical contact with a shaped portion of the insulated stencil (e.g., the outer surface 156 and the contact portion 157 of the pad 152, and the stencil 160), at 910. The shaped portion is at least one of a semi-permeable portion, a conductive portion, or an opening defined through the insulated stencil. The electrolytic fluid is then conveyed through the pad to the contact portion, at 912. The method 900 further includes electrically connecting a target surface connector to a target surface of an object to be marked (e.g., target surface connector 136, and target surface 192 of object 190), at 914. This can be referred to as “grounding” the target surface or work piece. The outer surface of the stencil and the contact portion are then placed in contact with the target surface, at 916 (e.g., the outer surface 156 of stencil 160, and the contact portion 157 of the pad 152). In addition, the method includes providing an electrical current through the target surface between the target surface connector and the electrolytic fluid driven through the pad covering an outer surface of the pad, at 918 (e.g., the target surface 192, and the target surface connector 156).

Method 900 can be easily and efficiently performed using an integrated, marker device having an attached reservoir and corresponding store of electrolytic fluid along with an optional internal power supply to further enhance the ease with which a user can perform the method, such as via marker devices 600 and 700 described above. In addition, method 900 can be performed quickly and with enhanced precision using a portable, integrated marker device having a pressurized reservoir configured to retain the electrolytic fluid at a positive differential pressure compared with ambient pressure prior to driving the electrolytic fluid to the contact portion, such that the positive differential pressure drives the electrolytic fluid through the pad to the contact portion of the stencil. Such an arrangement can provide a steady flow of the electrolytic fluid during marking operations, which can improve the precision of the mark formed in the contact surface along with enhancing the speed at which marking operations can be performed due to the improved flow of electrolytic fluid. Marker device 1000 shown in FIGS. 15-19 describes an example embodiment of a portable, integrated marker device having a pressurized reservoir that can readily be used to perform method 900 to mark various objects.

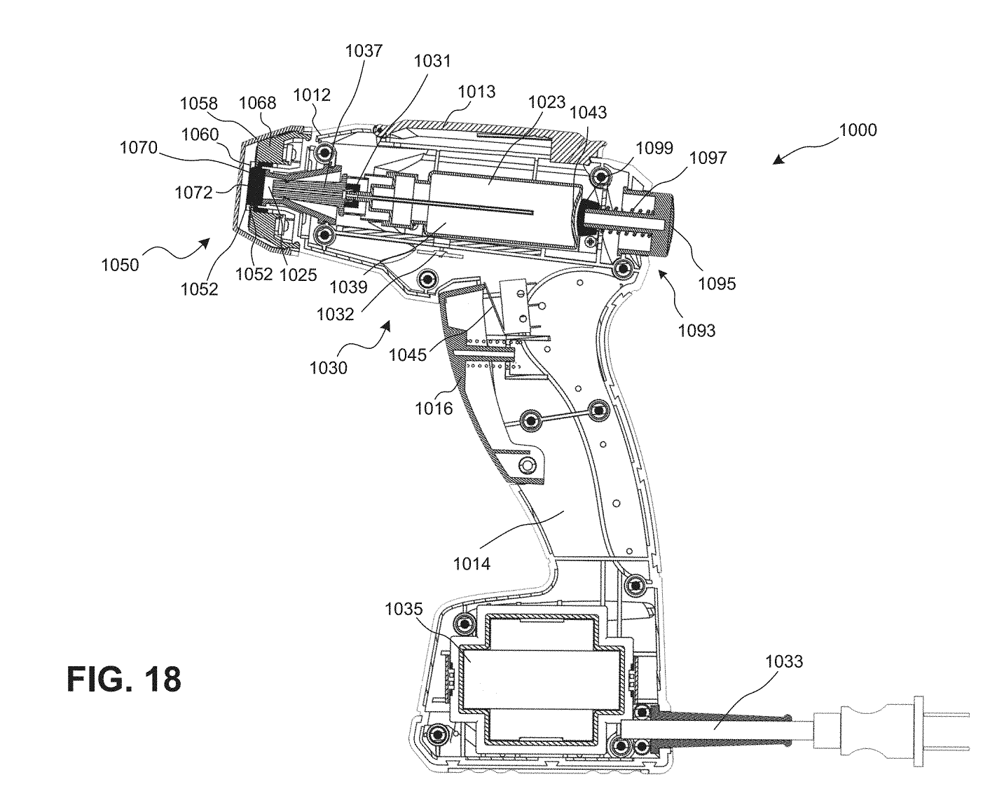

Referring now to FIGS. 15-19, a marker device 1000 is shown that includes many of the aspects and features of marker devices 100, 200, 500, 600 and 700, thus, certain aspects are not discussed in detail below. In particular, marker device 1000 shares many common aspects and features with portable, integrated marker device 600 described above and shown in FIGS. 9-11, and also can readily be used to perform method 900. Referring to FIGS. 15-19, integrated marker device 1000 includes a housing 1010, electrical components (also referred to as an electrical assembly) 1030, an on-board reservoir 1023 (FIG. 18), and a marker assembly 1050. The housing 1010 includes a distal end 1012, a generally opposite handle portion 1014, and an actuator 1016. The handle portion 1014 permits the user to manipulate the marker device 1000 and place the distal end 1012 proximate a surface of an object to be marked.

The reservoir 1023 is disposed within the housing 1010 (FIG. 18) and defines a volume within which the electrolytic fluid is contained. The reservoir 1023 is configured to retain the electrolytic fluid stored therein. In some embodiments, the reservoir (or container) 1023 can be pressurized (e.g., via the manual pump as described below, or by any other suitable mechanism) such that the electrolytic fluid is retained at a positive differential pressure compared with ambient pressure to perform marking operations. In some embodiments, the reservoir 1023 can be a pre-pressurized, sealed, replaceable reservoir 1023 lacking a fill port and not being refillable, which can permit the reservoir 1023 to retain and effectively store the electrolytic fluid within the reservoir under pressure. Upon actuation, a valve can be opened such that the pressurized fluid can be driven towards the pad fluid during marking operations. In other embodiments, however, the reservoir 1023 can be a refillable and/or reusable reservoir. In such embodiments, the reservoir can be pressurized (e.g., via the manual pump assembly 1093) during use to drive the electrolytic fluid. The housing 1010 includes an openable cover 1013 that covers the volume within the housing that contains the reservoir when closed, and provides access to remove and replace the reservoir when open.

The reservoir 1023 is coupled at its distal end to a valve 1031 that is disposed near the distal end 1012 of the housing and extends into the marker assembly 1050. The valve 1031 is coupled to a spray head 1037, which defines a lumen therethrough that can control the flow and/or a spray pattern of the electrolytic fluid exiting the reservoir. An opposite proximal end of the reservoir 1023 engages a manual pump assembly 1093 that extends rearward from the housing such that a rear portion of a pump handle 1095 extends out of the housing and is accessible to the user at a proximal end of the housing. The manual pump assembly 1093 includes the pump handle 1095, a biasing member 1097, and a plunger 1099. The plunger 1099 engages a rear portion 1043 of the reservoir 1023 within the housing, and the biasing member 1097 extends between a proximal portion of the plunger 1099 and an inner portion of the pump handle. The reservoir 1023 is slidably retained within the housing so that it can be moved forward within the housing toward the marker assembly 1050 when the manual pump assembly 1093 is actuated. The biasing member biases the reservoir 1023 distally away from the pump handle 1095 into engagement with the valve 1031, which also biases the pump handle 1095 proximally away from the reservoir 1023 such that a portion of the pump handle 1095 extends rearward out of the housing and is accessible to a user.

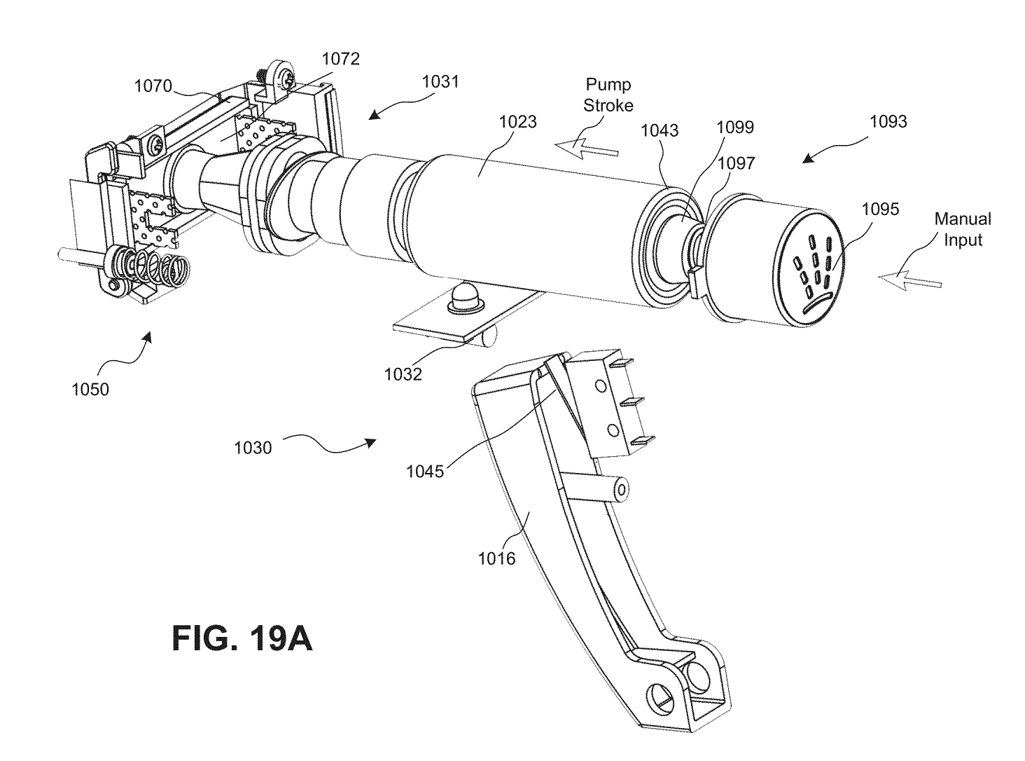

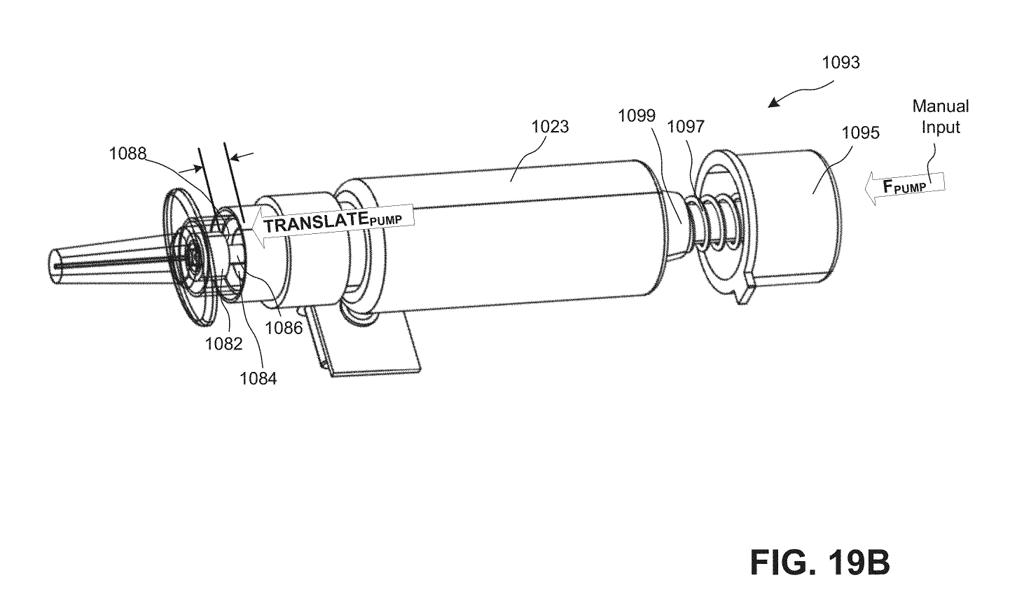

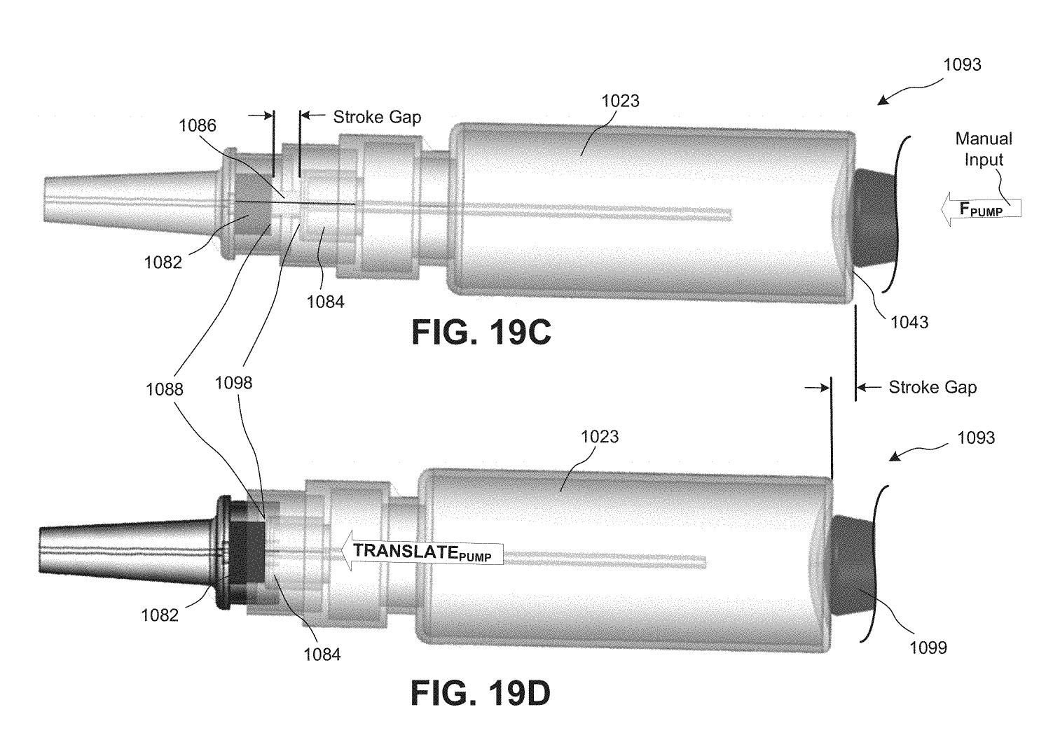

Referring to FIGS. 19A-D, the pump handle 1095 is configured to receive a manual input pump force from a user in a direction substantially parallel with a longitudinal axis of the reservoir 1023, which is configured to transfer the input pump force along the length of the reservoir and to thereby slidably translate toward the valve 1031. The distal end portion of the reservoir is configured to form a first end of a pumping mechanism for the manual pump 1093, and a proximal end portion of the valve 1031 is configured to form an opposite second end of the pumping mechanism of the manual pump, which are coupled to each other by a pump tube 1086 (see FIG. 19B) oriented along the longitudinal axis of the reservoir. A proximal stop 1084 is located along the pump tube 1086 at the first end of the pumping mechanism, and an opposite distal stop 1082 is located along the pump rod at the second end of the pumping mechanism. The proximal stop 1084 defines a proximal stop surface 1098 facing the distal stop 1082, and the distal stop 1082 defines a distal stop surface 1088 facing the proximal stop 1084. The proximal stop surface 1098 and the distal stop surface 1088 are configured to contact each other responsive to translation of the reservoir 1023 toward the valve 1031 as a result of the input pump force and thereby arrest the reservoir translation.

The translation of the reservoir is configured to operate as an input stroke for the manual pump assembly, during which the pumping mechanism is configured to increase a pressure within the reservoir in response to the input stroke. The internal pressure of the reservoir in combination with the pump handle bias member 1097 are configured to provide restoring forces along the longitudinal axis of the reservoir to complete the pumping action. The user can repeatedly apply an input pump force to the pump handle 1095 as appropriate to increase the reservoir internal pressure to reach a pre-determined differential pressure level vs. ambient pressure to apply a driving force to the electrolytic solution during a marking operation to provide a steady flow of the electrolyte for marking. In use, the actuation of the pump assembly 1093 can pressurize the reservoir 1023 and allow the electrolytic fluid to travel via the pump tube 1086 towards the valve 1031. The valve 1031 releases a predetermined volume of the electrolyte (e.g., based on the stroke), which is the sprayed into the fluid channel 1025 via the spray head 1037. The reservoir 1023 is fluidly coupled to the valve 1031 to provide a closed flow path from the reservoir into the valve channel 1025.

The conductive spacer 1072 blocks the outflow of electrolytic fluid from the valve channel, and is also configured to act as an automatic release for the valve 1031 during marking operations. The conductive spacer 1072 is formed from a selectively permeable material and/or includes geometric features (e.g., small flow openings formed therein) such that the conductive spacer 1072 permits the electrolytic fluid in the valve channel 1025 to flow through the conductive spacer when the electrolytic fluid at an input side of conductive spacer within the valve channel is at a pre-determined pressure, and when any electrolytic fluid at an opposite output side of the conductive spacer is at or near ambient pressure. In other words, when electrolytic fluid is able to flow away from the conductive spacer, such as during marking operations, without building up a back pressure greater than ambient pressure at the output side of the conductive spacer, such as when marking operations are not occurring, the conductive spacer 1072 is configured to permit a steady flow of pressurized electrolytic fluid out of the valve channel 1025. In some embodiments, the spray head 1037 can be configured to produce a predetermined droplet size or spray pattern, thereby producing a spatially uniform application of the electrolytic fluid towards the marking assembly 1050.

In addition, the marker electrode 1034 is formed as selectively permeable sheet that can cooperate with the conductive spacer 1072 to assist with automatically controlling the flow of pressurized electrolytic fluid at a steady rate during marking operations. Further, when configured as a sheet member, the marker electrode 1034 can provide a generally uniform electric current through the electrolytic fluid during marking operations. In a similar manner as the conductive spacer 1072 and the marker electrode 1034, the conductive base 1070 can also be formed as a selectively permeable member to further assist with guiding the flow of the electrolytic fluid during marking operations and controlling the flow rate of the fluid when driven under pressure from the reservoir 1023. The fluid can further be driven to flow to the pad 1052 and through the permeable portion(s) 1062 of the stencil during marking operations. A unitary cover 1058 is configured to be easily attached and removed from the marker assembly 1050. The unitary cover 1058 is configured to block the permeable portion(s) 1062 of the stencil 1060 and thereby stop the flow of electrolytic fluid during nonuse.

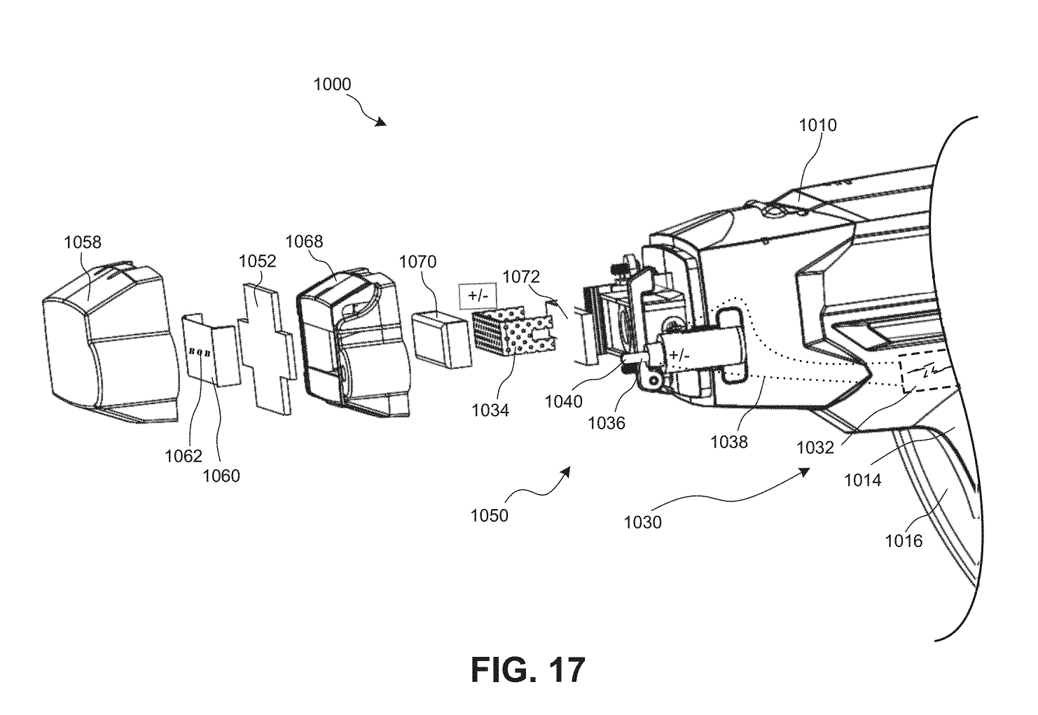

The electrical assembly 1030 is generally retained within the housing 1010 and include a current controller 1032, the marker electrode 1034, and a target surface connector 1036. The current controller 1032 is configured to be connected with a power source (e.g., the battery 1035). The marker electrode 1034 is connected to the current controller 1032, as indicated by the dotted lines in FIGS. 16 and 17. The marker electrode 1034 is attached within the distal end 1012 of the housing 1010. The target surface connector 1036 is disposed on the distal end 1012 of the housing and is configured to be electrically connected with the surface to be marked (e.g., a metallic object). The target surface connector 1036 extends through an opening formed in the insulated frame 1068 such that a tip 1040 is configured to be placed into contact with a surface to be marked when marker assembly 1050 is placed in position against the surface for marking operations. The target connector 1036 is also is connected to the current controller 1032, as indicated by the dotted lines 1038 in FIG. 17. Thus, when the marker device 1000 is placed in contact with the object to be marked, the user can activate the actuator/trigger 1016, as described below, which activates the current controller 1032 to provide electric current between the marker electrode 1034 and the target surface connector 1036 through the target surface of the object to be marked.

In some embodiments, the current controller 1032 controls an electric potential or current between the marker electrode 1034 and the target surface connector 1036 during a selected type of electrochemical marking (e.g., whether A/C or D/C, the magnitude of the current, the waveform of the current, and/or the characteristics of the current as a function of time during the marking operation). The electric potential can be determined according to the type of the electrochemical marking selected by the user and/or that corresponds with the object to be marked. Thus, based on the type of electrochemical marking selected by the user, the current controller 1032 provides the desired electric potential or current that includes at least a cathodic direct current electric potential, an anodic direct current electric potential, and an alternating current electric potential. Thus, the marker device 1000 can be used to mark many different types of conductive objects and perform various types of marking operations. In addition to the electric potential being customized for the type of marking and material to be marked, the current controller 1032 can adjust the characteristics of the electric current based on various parameters, such as automatically adjusting the current based on a flow rate of the electrolytic fluid sensed and/or the actual current detected during marking. In addition, the characteristics of the electric current can be optimized to enhance the type of mark provided, such as increasing or decreasing the voltage or magnitude of current applied during marking in accordance with a depth of material being added or removed from the surface.

Referring to FIG. 18, the actuator 1016 is configured as a single action movable trigger that operates to close a switch 1045 when initially moved rearward by the user, which activates the current controller 1032 to provide electrical current for etching operations. As such, the marker 1000 can be prepared for marking operations via the user applying input pump force as appropriate to pump handle 1095, and removing the unitary cover 1058 such that electrolytic fluid can be driven through the permeable portion(s) 1062 of the stencil. The application of electric current encourages initiation of a steady flow of the electrolytic fluid to the pad via the application of heat and wicking forces within the fluid. As the marking continues beyond the initial activation of the switch 1045, additional electrolytic fluid 1039 disposed in the reservoir 1023 is driven under pressure to flow from the valve path into the pad 1052 as described above. Such a configuration can provide a steady, controlled flow of electrolytic solution during marking without the use of additional powered devices such as an electric pump or a powered valve. As such, overall power consumption can be reduced in an inexpensive, yet efficient integrated marker. The marker 1000 includes a rechargeable internal battery 1035 and built-in recharging power cord 1033 to provide improved portability and flexibility regarding power options.

Referring now to FIG. 20, an embodiment for an integrated marker device 1100 that includes optional features for marker device 1000. As shown, marker device 1100 includes an optional external target surface connector 1178, which can provide improved electrical connections and flow through the target surface during marking operations. In addition, the front cover 1158 defines retention slots for holding the stencil during marking operations along with allowing for quick and easy replacement of the stencil without needing to remove the front cover 1158. During periods of nonuse and storage, the stencil can be replaced with a ‘blocker’ or ‘storage’ stencil that lacks any permeable portions in order to prevent inadvertent seepage of electrolytic fluid.

Although various embodiments have been described as having particular features and/or combinations of components, other embodiments are possible having a combination of any features and/or components from any of embodiments as discussed above. Aspects have been described in the general context of tools, portable devices or portable tools, and more specifically, integrated markers and portable markers, but inventive aspects are not necessarily limited to use in tools and portable devices.

The subject matter described above is provided by way of illustration only and should not be construed as limiting. Various modifications and changes may be made to the subject matter described herein without following the example embodiments and applications illustrated and described, and without departing from the true spirit and scope of the embodiments of the concepts and technologies disclosed herein.

1. An apparatus comprising:
a housing;
a current controller disposed within the housing, the current controller electrically connected to an electrode and a target surface connector, the current controller configured to be electrically connected to a power source; and
a metal marker assembly mounted to the housing, the metal marker assembly configured to contact a target surface to be marked, the metal marker assembly outlining a surface area to be marked on the target surface, the metal marker assembly including:
a pad connected to the electrode and configured to retain an electrolytic fluid; and
a cover removably coupled to the housing, the cover configured to retain an insulated stencil to an outer surface of the pad, the insulated stencil defining at least one permeable portion therein, a portion of the pad adjoining the at least one permeable portion when the cover retains the insulated stencil to the outer surface of the pad.

2. The apparatus of claim 1, wherein a distal end of the target surface connector is disposed at a portion of the metal marker assembly configured to contact the target surface.

3. The apparatus of claim 2, wherein the distal end of the target surface connector extends through an electrode opening defined through the cover.

4. The apparatus of claim 2, wherein the target surface connector includes a biasing member configured to bias the distal end against the target surface.

5. The apparatus of claim 1, wherein the target surface connector includes a removable clip configured to be electrically connected to the target surface.

6. The apparatus of claim 1, wherein the target surface connector includes a first contact portion and a second contact portion each configured to contact the target surface, the first contact portion extending through an opening defined by the cover, the first contact portion including a biasing member configured to maintain the first contact portion against the target surface, the second contact portion extending outside of the cover, the second contact portion including a clip to maintain the second contact portion in contact with the target surface.

7. The apparatus of claim 1, wherein the metal marker assembly includes an alignment mark configured to guide placement of the metal marker assembly in contact with the target surface.

8.-9. (canceled)

10. The apparatus of claim 1, wherein the cover includes a first portion and a second portion configured to enclose the pad and retain the insulated stencil over the outer surface of the pad, the first portion defining a first opening and the second portion defining a second opening, the first opening forming a cover opening through which the permeable portion extends and the second opening forming a cover opening through which the portion of the pad extends.

11.-14. (canceled)

15. The apparatus of claim 1, wherein:
the insulated stencil defines at least one stencil opening forming the at least one permeable portion;
the cover defines a cover opening; and
the portion of the pad extends into the at least one stencil opening and extends through the cover opening distally beyond an outer surface of the removable cover.

16. The apparatus of claim 1, further comprising:
a reservoir attached to the housing, the reservoir configured to contain the electrolytic fluid, the reservoir fluidically coupled to the pad via a conduit.

17.-21. (Canceled)

22. The apparatus of claim 1, wherein the current controller is configured to vary a characteristic of an electric potential between the electrode and the target surface connector to control an electric current between the electrode and the target surface connector, the electric potential varied based on a type of the electrochemical marking

23. The apparatus of claim 22, wherein the electric potential includes at least a cathodic direct current electric potential, an anodic direct current electric potential, and an alternating current electric potential.

24. An apparatus comprising:
a housing;
a current controller disposed within the housing, the current controller electrically connected to an electrode and a target surface connector, the current controller configured to be electrically connected to a power source;
a pad coupled to the housing and electrically connected to the electrode, the pad configured to retain an electrolytic fluid;
a cover removably coupled to the housing, the cover configured to retain an insulated stencil over an outer surface of the pad, the insulated stencil defining at least one permeable portion therein;
a conduit attached to the housing, the conduit defining a pathway through which the electrolytic fluid can be conveyed to the pad;
a reservoir attached to the housing and connected to the conduit, the reservoir configured to contain the electrolytic fluid; and
a valve configured to selectively permit the electrolytic fluid to flow from the reservoir to the pad at a pre-determined flow rate.

25. The apparatus of claim 24, wherein the reservoir is removably attached to the housing.

26. (canceled)

27. The apparatus of claim 24, further comprising:
a pump configured to drive the electrolytic fluid from the reservoir through the conduit to the pad.

28. The apparatus of claim 27, wherein:
the electrode includes a perforated metal surface; and
the pump is configured to drive the electrolytic fluid through the perforated metal surface to the pad.

29. (canceled)

30. The apparatus of claim 28, wherein:
the pump is a manual pump;
the reservoir is disposed within the housing and is included within the manual pump; and
the valve includes a permeable plug disposed within the conduit, the permeable plug configured to permit the electrolytic fluid to flow through the permeable plug.

31. The apparatus of claim 28, wherein:
The pump is configured to produce a pressure within the reservoir to drive the electrolytic fluid; and
the valve includes a permeable plug disposed within the conduit, the permeable plug configured to permit the electrolytic fluid to flow through the permeable plug at a pre-determined flow rate in accordance with the pressure.

32.-33. (canceled)

34. The apparatus of claim 24, further comprising:
an actuator coupled to the housing, the actuator configured to be manipulated by a user to move the actuator relative to the housing, a switch portion of the actuator configured to actuate a switch to electrically connect the current controller to the electrode; and
a sensor coupled to the housing, the sensor configured to sense an actual flow rate of the electrolytic fluid from the reservoir to the pad, the current controller configured to adjust the customized electric potential while performing electrochemical marking based on the actual flow rate of the electrolytic fluid.

35.-38. (canceled)

39. A method for marking on a target surface, the method comprising:
covering an outer surface of a pad configured to retain an electrolytic fluid with an insulated stencil so that a portion of the pad adjoins at least one permeable portion defined in the insulated stencil;
coupling the insulated stencil to the outer surface of the pad;
placing the at least one permeable portion of the insulated stencil in contact with the target surface;
electrically connecting a target surface connector to the target surface;
providing the electrolytic fluid to the pad; and
actuating a current controller within the housing to produce an electrical current arrangement through the target surface between the target surface connector and the electrolytic fluid provided to the pad, the current controller configured to apply a customized electric potential between the electrode and the target surface connector to produce the electric current arrangement between the electrode and the target surface connector during a selected type of electrochemical marking, the customized electric potential determined according to the selected type of the electrochemical marking and according to parameters for the selected type of the electrochemical marking, the parameters including at least one of a type of material of the target surface, a type of electrolytic fluid, a flow rate of the electrolytic fluid, a configuration for the electric current arrangement, and a comparison of an actual electric current sensed during the electrochemical marking in comparison with the electric current arrangement.

40.-47. (canceled)
